(19) United States
(12) Patent Application Publication
(10) Pub. No.: US 2019/0248439 A1
(43) Pub. Date: Aug. 15, 2019

(54) MOTORISED SCOOTER

(71) Applicant: Neuron Mobility Pte. Ltd., Singapore (SG)

(72) Inventor: Zizi WANG, Singapore (SG)

(21) Appl. No.: 16/310,272

(22) PCT Filed: Jun. 15, 2017
(86) PCT No.: PCT/SG2017/050303

§ 371 Date: Dec. 14, 2018

(30) Foreign Application Priority Data
Jun. 16, 2016 (SG) 10201604920Y
Jan. 20, 2017 (SG) 10201700513U
Feb. 21, 2017 (SG) 10201701350Y
May 24, 2017 (SG) PCT/SG2017/050268

(51) Int. Cl. B62K 11/10; B62K 3/00; B62K 15/00; B60L 53/24; B62H 5/00; B62J 99/00; G05D 1/02; B62H 1/10; G07C 5/08

(52) U.S. Cl. CPC B62K 11/10; B62K 2202/00; B62K 15/006; B60L 53/24; B62H 5/00; B62J 99/00; G05D 1/0214; B62H 1/10; G07C 5/085; G07C 5/0816; G05D 1/0257; G05D 1/0278; B62K 2204/00; B62K 2208/00; B60L 2200/12; B60L 2250/16; B60L 2250/10; B62J 2099/002; B62J 2099/0026; B62J 2099/004; B62K 3/002

(57) ABSTRACT

A motorised scooter comprises a framework for supporting a rider; a ground engaging element connected to the framework for moving the rider; an engine connected to the ground engaging element for propelling the ground engaging element; and a brake further connected to the framework, the ground engaging element, the engine or a combination of any these for stopping the motorised scooter. A method for using the motorised scooter comprises a step of a first step of receiving a request to use at least one motorised scooter; a second step of notifying location of the at least one suitable motorised scooter; a third step of offering the at least one suitable motorised scooter; and a fourth step of getting back the at least one suitable motorised scooter.

The present application claims a first priority date of Singapore patent application Number (SG)10201604920Y that was filed on 16 Jun. 2016, which has a title of Short Distance Mobility Sharing System.

The present application also claims a second priority date of Singapore patent application Number (SG)10201700513U that was filed on 20 Jan. 2017, which has a title of Docking Station for a Transport System.

The present application further claims a third priority date of Singapore patent application Number (SG)10201701350Y that was filed on 21 Feb. 2017, which has a title of Motorised Scooter.

The present application additionally claims a fourth priority date of international patent application Number PCT/SG2017/050268 that was filed on 24 May 2017, which has a title of Docking Station.

All subject matter or content of these above-mentioned four priority applications is hereby incorporated by reference.

The present application relates to a motorised scooter. The application also relates method for using, installing, repairing, configuring, upgrading, monitoring, dismantling, recycling and integrating the motorised scooter.

An electric scooter is a small platform with two or more wheels, which is propelled by an electric motor. Besides the electric motor, propulsion can also be assisted by a rider, pushing off to the ground. The presently common electric scooters have two wheels with inflatable tyres. Frames of the presently common electric scooters are made primarily of aluminium. Some electric scooters have single wheels (e.g. Self-Balancing Electric Unicycle), three or four wheels, or are made of plastic, or are large, or do not fold. Travelling speeds of the electric scooters range from about five kilometres per hour to a maximum speed of around thirty kilometres an hour usually.

An electric scooter provides a last mile transport to a commuter's destination from a public transport system. The public transport system includes trains and buses. However, it is often inconvenient to carry an electric scooter onto a bus or train. Brining an electric scooter into an office is even more disturbing or inconvenient. Therefore, a more user friendly or convenient electric scooter or motorised scooter is desired.

The present inventions aim to provide a new and useful motorised scooter as a mode of transport. The invention also aims to present new and useful methods of making, constructing, assembling, disassembling, installing, configuring, maintaining, managing and using the motorised scooter. Essential features of relevant inventions are provided by one or more independent claims, whilst important features of the inventions are presented by their dependent claims.

According to a first aspect, the present application provides a motorised scooter that comprises a framework for supporting or carrying a rider of the motorised scooter either on a deck or a seat of the framework. The motorised scooter optionally includes a personal transporter, an electric scooter, an electric kick scooter or a gas scooter, an electric motorcycle, scooter, electric bicycle (e-bike), a booster bike and a Personal Mobility Device (PMD). Examples of the motorised scooter include Segway PT, self-balancing scooter (i.e. self-balancing two-wheeled board, hover-board), self-balancing unicycle, mobility scooter, motor scooter (e.g. Vespa, Lambretta) and electric-powered kick scooter.

The motorised scooter further comprises a ground engaging element (e.g. one or more wheels that are possibly detachably connected to a side, a lateral side or an underside the framework for moving the rider of the motorised scooter and/or the framework on a substantially flat ground. The motorised scooter additionally comprises an electric, petrol or diesel engine (or simply known as engine), or at least a part of an engine (e.g. parts of an electric motor, linear motor or internal combustion engine) that is further possibly moveably connected to the ground engaging element, whether with contact or contactless. The engine connects the ground engaging element either directly or via a transmission for propelling or driving the ground engaging element in order to move the motorised scooter or rider on the ground. The engine is understood to be an accelerator because the engine is capable of increasing speed of the motorised scooter, although the engine does not preclude usage of other power source, such as manpower, wind power or gravity power.

The motorised scooter moreover comprises a brake that is further connected to the framework, the ground engaging element, the engine or a combination of any these for stopping the motorised scooter. The brake is alternatively known as a decelerator because the brake is operable to reduce speed of the motorised scooter. Advantageously, the brake is connected to a rear wheel or tail part of the motorised scooter in order to prevented tumbling of the motorised scooter in case of sudden stopping. The brake is optionally integrated with the engine or transmission of the motorised scooter, which provides engine braking. In some cases, the brake sharp reduction of speed top the motorised scooter, such as by applying a reverse momentum to the motorised scooter temporarily.

The motorised scooter provides convenience of personal transport, especially in a congested or busy city. A rider of the motorised scooter is able to move smoothly through traffic jam, crowded pavement (i.e. sidewalk) or dedicated bicycle lanes almost unhindered, which provides comfort, speed and flexibility in route.

The motorised scooter further comprises an identification, an electronic identification, a unique identifier, an electronic identification, a machine identifier, a machine-readable identification, an electronic identifier or simply an identifier attached or assigned to the motorised scooter, which is able to uniquely identify or differentiate the motorised scooter from others motorised scooters, electric scooters, bicycles or automobiles. The identification, the electronic identification, the unique identifier, the machine identifier, the machine-readable identifier, the electronic identifier or the identifier is possible to be static (e.g. permanent assigned to the motorised scooter) or dynamic (e.g. modified or updated according to circumstance or time). The identification code facilitates automatic recognition and/or data capture (AIDC) so that the motorised scooter can be automatically identified, which is also known as “Automatic Identification,” “Auto-ID,” and “Automatic Data Capture”. AIDC Technologies include bar codes, Radio Frequency Identification (RFID), biometrics (e.g. iris and facial recognition system), magnetic stripes, Optical Character Recognition (OCR), smart cards, and voice recognition.

The identification includes an electronic identification code, electronic identification or identification code which is readable or detectable by an electronic device, an electronic reader or scanner, or a communication instrument (e.g. mobile phone or smartphone). The identification or electronic identification can have different forms, such as an electronic address, a machine readable number or code, a physical trait or parameter, or a combination of any of these. Examples of the electronic address include a Wi-Fi MAC (Media Access Control) address, an IPv4 (Internet Protocol version 4) address, an IPv6 (Internet Protocol version 6) address, an IMEI (International Mobile Equipment Identity) address, a telephone number, a MSISDN (Mobile Station Integrated Services Digital Network number), an intemational mobile subscriber identity (IMSI) number and its related key as stored by a SIM (subscriber identity module or subscriber identification module) card, an Integrated Circuit Card Identifier (ICCID), a Bluetooth address, Ethernet MAC (Media Access Control) address. Examples of the machine-readable number, machine-readable code or machine-readable data includes a serial number, a time stamp, a linear barcode and a matrix (2D) barcode (e.g. Quick Response Code, Data Matrix code). The physical trait or parameter includes mileage of a motorised scooter, a geographic coordinate of a motorised scooter, an engine number of a motorised scooter, and an identifier of any component of a motorised scooter.

The identification of the motorised scooter is optionally being remotely or wirelessly accessed, detected or read, without being locally retrieved. Hence, a rider or operator of the motorised scooter does not have to get close to or physically reach the motorised scooter to identify the scooter, offering much convenience. The motorised scooter with the identification is advantageously being tracked or monitored when moving or stationary. For example, the motorised scooter periodically communicates with a base station to report its location by using its identification. An operator of the motorised scooter is kept informed about motorised scooter continuously and automatically.

The identification, which is also known as electronic identification, unique identifier, electronic identification, machine identifier, machine-readable identification, electronic identifier or simply identifier, is possible to be read or exclusively read by an electronic communication device (e.g. smartphone). For example, the identification is implemented by a RFID (Radio-Frequency IDentification) chip embedded in the control unit, which is readable by a machine reader, but not by a human being.

With the identification (alternatively known as electronic identification, unique identifier, electronic identification, machine identifier, machine-readable identification, electronic identifier or identifier), the motorised scooter is able to recognised automatically by machine reader or scanner so that either a user, a rider or an operator of the motorised scooter is able to record or track usage of the motorised scooter automatically, such as by a remote computing server of the operator or a smartphone of the user or rider. Handover or monetary transaction over the motorised scooter becomes clear, swift, transparent, verifiable or auditable. Both private individuals, organisations and government authorities are able to regulate deployment, usage or maintenance of the motorised scooter with clarity and integrity. If multiple or many such motorised scooters are made available to public, identification of these motorised scooter offers possibility data analytics, fleet management and optimisation of operation.

Embodiments of the application provide the motorised scooter that further comprises an on-board energy source, which is connected to the engine for driving the engine in order to propel the ground engaging element, the framework or the rider. Examples of the on-board energy source or energy source include a fuel tank, an automotive battery, a rechargeable battery or a cluster of any of these. For instance, the on-board energy source comprises multiple pieces of rechargeable batteries that are connected in series or parallel, whilst each piece of these rechargeable batteries is detachable from the cluster. The on-board energy source offers freedom to the motorised scooter because the motorised scooter is able to move away from a fixed location. Shape, size, weight or capacity of the on-board energy source optionally conforms usage, rider requirements and profiles of the motorised scooter. For example, the on-board energy comprises a hermetically box that is affixed to a lower portion of a steering column of an electric scooter. The hermetically box or the on-board energy is possible to be snapped or clicked onto the steering column by human hands and without any tool.

The motorised scooter optionally further comprises an electronic or computerised control unit (e.g. having a CPU or an Operating System) or control unit that is connected to the engine and optionally the energy source for regulating speed or torque of a transmission (mechanics), a powertrain, a powerplant, the engine, the energy source or a combination of any of these. The control unit regulates various parts or components of the motorised scooter so that a rider or user of the motorised scooter is partially or fully relieved from mundane or routine operation of the motorised scooter. For example, the control unit receives a control signal of maintaining constant speed of the motorised scooter and checks steepness or slope of an inclined road so that the control unit is able to automatically adjust torque of the engine or its transmission in order to keep up with climbing or descending at a substantially constant speed.

The control unit can comprise a scooter regulator or an energy source regulator (e.g. battery charging module) for managing replenishment process of the on-board energy source or the energy source according to at least one predetermined protocol.

For example, the energy source regulator includes a battery charging module that is operable to optimised charging one or more rechargeable battery cells of the motorised scooter. One predetermined protocol includes providing a constant voltage for charging a rechargeable battery of an electric scooter, which is known as a motorised scooter. Another charging protocol includes providing large electric current for charging a rechargeable battery of an electric scooter during peak or rush hours (e.g. 07:30-09:30 & 17:00-20:00), whilst providing small or medium electric current for charging a rechargeable battery of an electric scooter during off-peak hours (e.g. 0:00-06:00 & 21:00-24:00). A further example of the charging protocol includes notifying the dashboard, an illuminator or the motorised scooter, a mobile communication device of a rider or user if an electric scooter is ready for hiring. For example, a rider informs an operator of the motorised scooter that his planned journey is about 5 kilometres. The charging protocol of many electric scooters is able to inform the rider or user that several sufficiently charged electric scooters are ready for his hiring, which have sufficient electric power storage to cover 150% of the planned distance (i.e. 7.5 kilometres), and not necessarily 100% (i.e. fully) charged.

The scooter regulator or energy source regulator may comprise control logics or programmes that are operable to examine the motorised scooter automatically. For example, the control logics or programmes examine battery level of an on-board battery of an electric scooter, sensors conditions of the control unit and operation readiness of an operating system of the control unit. The control logics or programmes may be able to perform self-check or self-examination automatically so that a user, a rider or an operator of the motorised scooter is informed about readiness or condition of the motorised scooter. The control logics or programmes may be updated, configured, installed, uninstalled or patched by a rider, a user, an operator or the motorised scooter itself automatically, depending on setting or configuration of the control unit or motorised scooter.

The control unit can comprise a user interface for operating or interacting with the user, rider or operator. The user interface includes many types, such as graphic, text, tactile or haptic (i.e. touch user interface), button, light indicators, camera, LED indicator or illuminator (e.g. tungsten filament incandescent lamp or a halogen incandescent lamp. LEDs and high intensity discharge lights), shaft, handle, peddle, joystick, sensors or transducers, microphone, throttle or thrust lever, knob, microphone, speaker for audio guidance or narrator. For example, the user interface includes a touchscreen or tactile display that is layered on top of an electronic visual display of an information processing system. A rider can give input or control the information processing system through simple or multi-touch gestures by contacting the touchscreen with a special stylus and/or one or more fingers. The user interface can further include a finger print reader, an iris reader, a face recognition system, a voice recognition device or any other biometric devices.

In some cases, the sensors include an alcohol sensor that can detect concentration level of alcohol in a breath of a rider of the motorised scooter. The control unit with the alcohol sensor is also known as an ignition/engine interlock device, breath alcohol ignition interlock device (IID and BAIID) or a breathalyser that can analyse breath of the rider before powering the motorised scooter. If resultant breath-alcohol concentration analysed result of the rider is greater than a predetermined programmed blood alcohol concentration level, the control unit with the alcohol sensor prevents the engine from being started or initiated.

The user interface may comprise a dashboard (i.e. dash, instrument panel, fascia or control panel) for displaying operation parameters of the motorised scooter. The operation parameters may include remaining battery level, travel speed of the motorised scooter, local map of the motorised scooter, estimated remaining time or distance available based on the remaining battery level, direction of travel and locations of nearby docking stations for the motorised scooter. For example, the dashboard shows remaining capacity (e.g. battery level) of the on-board energy source by an array of colour LED indicators. The control unit has an odometer or odograph that enables the dashboard to provide mileage or distance travelled by the motorised scooter. The dashboard provides clear summary of vital information that is useful to a rider of the motorised scooter.

The control unit can comprise a lock for preventing or stopping operation of the motorised scooter. The lock comprises a mechanical lock, an electronic lock, a computerised lock or a combination of any of these. For example, a computerised lock is able to recognise biometric identifiers (e.g. fingerprint, palm veins, face recognition, DNA (DeoxyriboNucleic Acid), palm print, hand geometry, iris, retina and odour/scent) for activating the lock or deactivating the lock. The lock may be wirelessly activated or deactivated. For example, the control unit has a GSM/GPRS Module (e.g. model No. SM5100B) so that an operator of the motorised scooter is operable activate a lock of the motorised scooter remotely via SMS (Short Message Service) text message, GSM/GPRS (Global System for Mobile Communications/General Packet Radio Service) or TCP/IP (Transmission Control Protocol/Internet Protocol) signals. One example of the lock includes a front wheel turning mechanism that forces one or more front wheels of the motorised scooter to turn and become perpendicular to a travel direction or longitudinal axis of the motorised scooter so that a locked motorised scooter can only circle around its rear wheels, being prevented from moving forward. For example, the lock prevents the motorised scooter from moving (e.g. jam its wheels in direction, rotation or both) and send off alarm signals to the operator if detecting unauthorised usage (e.g. motorised scooter stolen from a docking station) of the motorised scooter.

The control unit may additionally comprise an indoor or outdoor navigation device (i.e. indoor or outdoor navigator), an inertia navigation device or a combination of any of these navigation devices for recording geographical location of the motorised scooter. Outdoor navigation devices (also known as outdoor navigator) include radio-navigation systems, such as Global Positioning System (GPS), Russian GLONASS (Global Navigation Satellite System), Chinese BeiDou-2 (formerly known as COMPASS) or European Galileo (global navigation satellite system of European Space Agency). Indoor navigation devices or indoor positioning system (IPS) includes, which may be optical, radio or acoustic. For example, the indoor position system includes inertial measurement unit (IMU), monocular camera Simultaneous localization and mapping (SLAM) and WiFi SLAM. Integration of data from various navigation systems of the indoor positioning system with different physical principles or with the outdoor radio-navigation systems can increase the accuracy and robustness of the overall solution. The navigation device or navigator, whether indoor or outdoor, is able to check and report location of the motorised scooter regularly, periodically or continuously, offering location and speed information of the motorised scooter. One or more smoothing algorithms may be adopted by the navigation device or navigator to facilitate real-time data analytics, even when the motorised scooter entering weak-signal areas (e.g. next to high-rise buildings or underroof).

The indoor navigation device, alternatively known as indoor positioning system (IPS) or indoor navigator, is able to measure distance with nearby anchor nodes (i.e. nodes with known positions, e.g., WiFi access points), magnetic positioning, dead reckoning.

The inertia navigation device, also known as inertia navigation system or inertia navigator, is a navigation aid that uses a computer, motion sensors (accelerometers) and rotation sensors (gyroscopes) to continuously calculate via dead reckoning the position, orientation, and velocity (direction and speed of movement) of a moving object without the need for external references.

Optionally, with the navigation device, the motorised scooter is able to move to a predetermined place (e.g. docking station, bus stop) automatically. Accordingly, the navigation-enabled motorised scooter becomes an automated guided vehicle, automatic guided vehicle (AGV) or a driverless vehicle. Navigation technique examples of the motorised scooter may further include wired or slot guided, tape guided, laser target navigation guided, inertial (gyroscopic) navigation, natural features (natural targeting) navigation, vision guidance.

The control unit optionally comprises an alarm for indicating malfunctioning of the motorised scooter. The alarm is also known as an alarm bell, alarm device or siren, which gives an audible, visual, electric/electronic signal or other form of alarm signal about a problem or condition of the motorised scooter, its rider or user. The alarm device is optionally connected to sensors or transducers so that the alarm device is capable of sending text messages, visual signals (e.g. flashing of red LED lights), audible signals (e.g. beeps), electronic signals (e.g. data packets to a mobile phone of a rider of the motorised scooter) or haptic signal (e.g. vibration of handles), or a combination of any of these signals. Alarm signals are able to transmitted or broadcasted locally (e.g. at the motorised scooter), remotely (e.g. to a computing server of an operator of the motorised scooter), or both. The alarm signals are optionally accompanied by emergency actions, such as applying or activating brake of the motorised scooter. Often, the alarm device sends off alarm signals if a rider loses control or balance to a motorised scooter. Sometimes, the alarm device emits alarm signals if the motorised scooter exceeds prescribed speed limits, specified PMD-free zones according to geo-fences, or any other operator's or rider's rules. In extreme cases, the alarm or alarm device send off alarm signals to both the rider and operator of the motorised scooter if the motorised scooter loses control (e.g. by on-board sensor detection), and the control unit takes over control of the motorised scooter or simply lock the motorised scooter.

Embodiments of the application provide that the control unit comprises a recorder (e.g. audio, video or electronic signal recorder for recording sensor signals), an on-board recorder (e.g. dash cam, dashboard camera, car DVR, or car black box), a detachable recorder (e.g. rider's smartphone), or a remotely connected recorder (e.g. cloud based) for recording usage data of the motorised scooter, such as video recording of a trip. The recorder sometimes includes one or more non-volatile memory (e.g. magnetic tape, solid-state drive or disk), whether internally or externally. For example, the recorder includes a dashcam (i.e. dashboard camera, car DVR, or car black box) that is automatically activated when its connected motorised scooter moves. The dashcam is optionally activated by electronic signals from the engine or by motion detection software programme of the dashcam.

The control unit can further comprise a road object detector or object detector for checking road obstacles. The detector can be mechanical (e.g. lever), electric (e.g. limit switch), electronic (e.g. optical sensor), computerised (e.g. by programming) or in combination of any of these forms so that the motorised scooter becomes aware of its surroundings when in motion or stationary. The road object detector or object detector can be connected locally to a smartphone or remotely to a computing server (known as cloud server or cloud) so that the road object detector or object detector can detect physical objects as well as artificial boundaries (e.g. by geo-fences). The motorised scooter, a rider of the motorised scooter or an operator (also known as service provider) of the motorised scooter can be alerted automatically (e.g. by audio alarm or electronic signals) for taking necessary actions. Examples of the object detector include a radar (RAdio Detection And Ranging or RAdio Direction And Ranging) and Lidar (LIDAR, LiDAR, and LADAR).

The control unit may comprise a PMD (Personal Mobility Device) assistant (also known as intelligent PMD assistance system or iPAS (Intelligent PMD Assistance System), safety regulator) for safety compliance of the motorised scooter. The assistance system (i.e. iPAS) may be able to alert users or riders in the events of speeding, riding on PMD-free zones such as roads and carparks, and emergent situations such as approaching children, elderly and disabled, approaching crowded areas, and oncoming PMDs or bicycles. An active control mechanism may also be built in the assistance system to take over control of the motorised scooter in case of emergency. The iPAS may comprise following three modules, which include a geospatial analytics module, a video/audio analytics module and a control module. The geospatial analytics module may track PMDs' (e.g. motorised scooters') speed and location in real-time, correct location errors, and alert riders upon speeding and riding on PMD-free zones based on geo-fences and speed limit rules (i.e., 15 km/h on footpaths and 25 km/h on shared paths and cycling paths). The video/audio analytics module may detect and understand the surrounding traffic patterns on footpaths, cycling paths and shared paths, and alert riders in emergent situations. The control module may send electric or electronic signals to parts of the motorised scooter based on combined inputs from both the geospatial analytics and video/audio analytics modules.

The control unit can be configured or operable to regulate the motorised scooter according to geo-fence for compliance. A geo-fence is a virtual perimeter for a real-world geographic area. The geo-fence is possibly dynamically generated, as in a radius around a store or point location. The geo-fence can alternatively be a predefined set of boundaries, like school attendance zones or neighbourhood boundaries. The control unit is programmed to utilise the geo-fence, known as geo-fencing. For instance, the control unit involves a location-aware device of a location-based service (LBS) user entering or exiting a geo-fence. This activity can trigger an alert or alarm signal to a rider of the motorised scooter as well as messaging to an operator of the motorised scooter. Relevant information of the geo-fence or geo-fencing is plausible to be sent to a mobile telephone or an email account of the rider. Hence, the operator (computing server provider or geo-fence provider) or regulator (e.g. government or traffic police) is able to regulate the motorised scooter wirelessly or remotely so that riders or users of the motorised scooter(s) are confined within prescribed limits (e.g. time, location, distance, and cost). For instance, the control unit will send alarm signals (e.g. audio or wireless electronic signals) to riders and the operator if the motorised scooter enters restricted zones (e.g. lawns for children's play). Moreover, the control unit is able to automatically capture information of risky riders (e.g. by frequent sudden speeding) or regulate the motorised scooter when necessary. Embodiments of the application indicate that the motorised scooter automatically slows down when near vulnerable people groups (e.g. children, elderly and disabled persons); approaching crowded areas (e.g. bus stops) or school zones; or meeting other PMDs (e.g. bicycles, kick scooters, roller skate boards).

The control unit further optionally comprises an energy harvester that is configured to collect solar energy, wind energy or vibration energy (e.g. by piezoelectric devices installed on a damper or shock absorber). For example, a communication terminal of the control unit is connected to an on-board solar panel so that the communication module is able to send electronic signals of its location to an operator, even if batteries of the motorised scooter is completely depleted or malfunctioning.

The control unit may comprise a charging connector (e.g. socket, pins) that is weatherproof, dustproof or waterproof. More conveniently, the charging connector is exposed (e.g. with multiple pins) or spring-loaded so that the charging connector automatically may attach to an energy supplier (e.g. mains or electrical grid) when the motorised scooter is coupled to a docking station (known as docked), without requiring additional actions from a rider. For example, the energy supplier has a sleeve that is receivable to a shaft having three electrically conductive contact pads for coupling with the sleeve. The charging connector is able to electrically connect to a charger or an energy source by wires or wirelessly, whilst a charging or replenishing process of the motorised scooter is uninhibited by foreign particles, rainwater, ice or snow. For example, the charging connector is waterproof and dustproof, having an IP68 (according to International Protection Marking), whether connected or disconnected to a charger or energy source. More advantageously, the charging connector is connector-integrated (i.e. without extension cables or wires, similar to the concept of USB plug) and located on the motorised scooter. When a rider pushes the motorised scooter to a docking station, the charging connector directly couples with a port or socket of the docking station at similar or same height so that no additional connecting action may be necessary from the rider. For instance, the charging connector has a height of below 125 centimetres, 95 centimetres, 75 centimetres, 55 centimetres, 35 centimetres or 15 centimetres, measuring from the ground or a base surface of the grounding engaging element. Of course, the charging connector may additionally comprise a wireless charger (also known as inductive charging) or WiFi power charger so that a rechargeable battery of the motorised scooter may be powered up at a docking station or on the move.

The control unit can comprise an energy source regulator connectable to the energy source for managing the energy source according to one or many predetermined protocols or charging protocols. For example, the protocols include charging protocols for charging a rechargeable battery of an electric scooter. A peak-hour charging protocol of the protocols is programmed to charge the rechargeable battery as fast as possible (e.g. fast charging of 30 minutes). An off-peak charging protocol of the protocols is programmed to charge the rechargeable battery with low electric current so that lifespan of the rechargeable battery can be extended, prolonged or preserved.

The control unit may further comprise a communication terminal or module for tracking location or position of the motorised scooter (e.g. by telematics), or contacting external electronic devices (e.g. a mobile phone). The communication terminal may be able to communicate with a mobile communication device (e.g. smartphone, iPad™) with wires or wirelessly. For instance, the communication terminal comprises an antenna (e.g. GPS antenna, WiFi antenna) for wireless communication. The antenna is possibly printed on a PCB (Printed Circuit Board) of the communication terminal, detachably plugged into a PCB of the communication terminal, or soldered with a PCB of the communication terminal. Possible electronic communication modes that utilise the antenna include NFC (near-field communication), Zigbee (IEEE 802.15.4-based), Wi-Fi (IEEE 802.11 standard), Bluetooth (IEEE 802.15.1) and other wireless communication protocols.

The communication terminal or module may be operable or programmed to communicate with other electronic devices via a communication protocol, which comprises PARC Universal Packet, Internet protocol suite, AppleTalk, DECnet, IPX/SPX, Open Systems Interconnection (OSI), Systems Network Architecture (SNA), Transmission Control Protocol (TCP), User Datagram Protocol (UDP), Internet Control Message Protocol (ICMP), Hypertext Transfer Protocol (HTTP), Post Office Protocol (POP), File Transfer Protocol (FTP), Internet Message Access Protocol (IMAP), General Inter-ORB Protocol (GIOP), Java remote method invocation (RMI), Distributed Component Object Model (DCOM), Dynamic Data Exchange (DDE) and SOAP (originally Simple Object Access Protocol). The communication protocol includes one or more encryption algorithms, or modulation so that electronic messages, data or signals cannot be intercepted or read by unauthorised parties. The communication terminal or module may communicate with external devices passively, actively or both.

The communication terminal or module can comprise a computer (hardware) port for wired communication. The computer port includes a serial port (e.g. RS-232), a parallel port (e.g. DB-25, DB25F, “Centronics” 36-pin Amphenol, DC-37), a hot-swappable port, a plug-and-play port (e.g. USB port, FireWire port, a lightning connector port of Apple Inc., Apple 30-pin dock connector port). The communication terminal facilitates the control unit to exchange information with other electronic devise, or even operate the motorised scooter by a remote computing server.

According to some implementations, the engine, the energy source, the control unit, their connections or other parts of the motorised scooter are weatherproof (e.g. hermetically sealed, waterproof, dustproof). Particularly, the dashboard or display screen of the control unit is possibly waterproof so that the motorised scooter is able to be operated reliably in rain, snow or storm. Accordingly, the motorised scooter becomes robust or reliable for operation in diverse types of environments, e.g. snowing north, tropical south or raining countries.

In some cases, one or more parts (e.g. component or connection between components) are adjustable (e.g. extendable, rotatable, movable, foldable) to suit or fit riders of different sizes. For example, a deck or foot deck of the motorised scooter has two halves so that the deck becomes foldable by closing the two halves. Another example of the one or more parts include a steering column whose height is adjustable and lockable so that a standardised motorised scooter is able to suit riders of different statues. Some samples of the motorised scooter or its framework is collapsible or foldable. The deck may have a top surface that is resilient, corrosion resistant, non-slippery (e.g. rubber surface) or roughened (e.g. having grained surface or anti-slip steel grating or other materials' grating). Particularly, the deck, foot deck or foot platform optionally comprises water drainage structure. For example, a cross-section of the deck has a budging or convex curvature so that rainwater tends to flow down the deck under gravity naturally. Alternatively, the deck has perforations or some through holes (e.g. square holes, circular holes, hexagon holes) from top to bottom so that rainwater is able to drain off from the deck. The top surface of the deck may further be free from sharp objects so that the deck become safe and comfortable to riders. In other words, the deck may be termed as a safe deck, which prevents pricking, slipping or splashing.

Advantageously or optionally, one or more components of the motorised scooter comprise modular structure for coupling or decoupling with or without tools. For example, parts or components of motorised scooter can be detached for replacement. Electric cables or wires have connectors so that a single cable or wire is able to be disconnected by decoupling the connectors. The modular structure applies to mechanical or electrical components or parts of the motorised scooter. For instance, a modular electric cable (e.g. control wire) has several segments that are coupled in series by connectors, whereby the connectors are easily handled by bare hands with using tools.

The framework, the control unit or both may comprise a stabiliser (e.g. a gyroscopic balancer, a supporting stand, as in Lit Motor C-1) for providing dynamic or static balance to the motorised scooter. The stabiliser may provide dynamic or static balance to the motorised scooter so that the motorised scooter is able to stand upright, whether during motion or being parked. A gyroscopic balancer may operate like a control moment gyroscope or a reaction wheel that assists a novice rider to maintain balance easily. The stabiliser may be in the form of one or more kickstands for keeping static balance of the motorised scooter.

The framework can further comprise a holder for carrying a bag of the rider. For example, the holder includes a hook, a clip, a fork or any other fixture that is able to fasten an object to the motorised scooter. The rider can conveniently put or lock his handbag into the basket or container with a closing lid for easy carrying, instead burdening his shoulder. The container and its lockable lid can be waterproof so that a rider can safely leave the motorised scooter in the rain, without spoiling documents inside the container. Moreover, one or many parts of the motorised scooter may be water repellent or water resistant (e.g. having drainage holes on a deck of the motorised scooter). The holder, the basket or the container can comprise collapsible, detachable or lockable mechanism for carrying the bag a helmet, gloves, shoes securely, even on bumpy roads.

The framework may further comprise a socket or connector for permanently or detachably mounting a seat for the rider. The socket or connector facilitates attachment of a seat so that a rider of the motorised scooter is able to sit on the seat for travelling long distance with comfort and ease.

The framework or any other parts of the motorised scooter can be made of light-weight material (e.g. aluminium alloy 2099 having aluminium content 94.3%) or structure (e.g. hollow shaft, ribbed deck). The light weight material and/or structure enables construction of a compact and light-weight scooter, such as being less than 15 kilograms or 10 kilograms, including battery of an electric scooter (i.e. a form of motorised scooter).

Embodiments of the application provide a motorised scooter whose one or more portions of surfaces are capable of self-clean. For example, the framework is coated with a thin titanium dioxide (TiO2) film. Exposed areas of the framework are optionally superhydrophobic, which is possible to be created by plasma or ion etching, crystal growth on a material surface, or nanolithography. The portion of self-cleaning surfaces has an inherent ability to remove any debris or bacteria from the surfaces in a variety of ways. The portion of self-cleaning surfaces can be placed into three categories, which is superhydrophobic, superhydrophilic and photocatalytic. Hence, the motorised scooter requires less maintenance and has excellent image (e.g. shining framework) throughout its service or usage period, whilst requiring minimum cleaning.

According to a second or another aspect, the present application provides a method of using a motorised scooter. The method comprises a first step of receiving an electronic request from a rider or user to use at least one motorised scooter; a second step of notifying the user or rider with location of the one or more suitable motorised scooters, possibly to a mobile communication device of the user or rider; a third step of offering (e.g. unlocking, indicating, highlighting) the one or more suitable motorised scooters to the rider or user; and a fourth step of accepting, collecting or retrieving the one or more at least one suitable motorised scooter. The fourth step of accepting, collecting or retrieving is also known as getting back the one or more suitable motorised scooters. Some of these steps are possible to be divided, combined or changed in sequence. Hence, the method provides business or service opportunities that many users or riders can share motorised scooters without much concern about maintenance or logistics. Since an operator or business owner is able to provide docking stations distributed over several locations, riders of the motorised scooters are able to rent, pick or get a fully charged electric scooter at a place of convenience. A rider who rents a motorised scooter or electric scooter does not have to charge or maintain the motorised scooter or electric scooter after his usage. Instead, the rider can either return the motorised scooter or electric scooter to a docking station of the operator, or leave the used motorised scooter or electric scooter at a publically accessible place. The operator is able to obtain location information of the used motorised/electric scooter via an outdoor positing system (e.g. the scooter emits signals using 2G telecom network), collect and redeploy the used scooter to another place or another docking station. The motorised scooters or electric scooters are able to be more efficiently, effectively and profitably used, for the operator, rider and user.

The method can further comprise a step of transacting, whether electronically or by other means (e.g. cash), over usage of the one or more motorised scooters. Accordingly, users or riders share financial burden of many motorised scooters and their docking stations, enjoying convenience of getting a motorised scooter in his vicinity, whenever in a city.

The step of transacting, whether electronically or not, over usage of one or more suitable motorised scooters may comprise a step of associating one or more electronic identifier of the one or more suitable motorised scooters with the electronic identities of the users or riders respectively. The electronic identities or identifiers of the users or riders may be provided by electronic addresses or identifiers of mobile communication devices (e.g. smartphones) of the users or riders respectively. The step of associating identifiers of the motorised scooter and the rider may further include associating with one or more docking stations of the motorised scooter so that an operator may provide accurate and complete records of transactions or handling of relevant motorised scooters, preventing fraud or chaotic handlings.

The method can additionally include a step of checking an electronic identity of the user or rider, such as via his mobile communication device (e.g. smartphone or mobile phone). Since checking can be instantaneous, verifiable by multiple factors (e.g. SMS, WhatsApp message, phone call), both the rider and the operator are assured of secure and reliable usage and transaction.

The method may further comprise a step of replenishing an on-board energy source (e.g. fuel tank, rechargeable battery) of the motorised scooter according to one or more predetermined protocols (e.g. peak hour protocol, off-peak hour protocol). The one or more predetermined protocols may be periodically or continuously updated or configured to suit changing situation or usage patterns. For example, one predetermined charging protocol requires fastest charging during peak hours, whilst another predetermined charging protocol offers low electric current charging for extending battery life.

The method can further comprise a step of communicating with a mobile communication device of the rider or user over the transaction. Due to prevalent availability of mobile phones, each rider or user will normally have a mobile phone that is able to communicate with the motorised scooter, a docking station of the motorised scooter or a remote computing server of an operator (e.g. via internet). The transaction can be seamlessly and conveniently handled over online platforms so that administration of the transaction or operation is made simple and enjoyable.

The method may further comprise a step of locking the one or more suitable motorised scooter to a docking location or at an accessible public or private place. For example, upon completion of a journey, a rider may return a rented motorised scooter to a nearby docking station, and couple the motorised scooter to a docking station or stand. Upon coupling, the docking station, the motorised scooter and/or the mobile communication device of the rider performs examination and transaction of the motorised scooter (e.g. calculating rent charges of usage distance or time), and fastening (e.g. locking) the motorised scooter to a docking station or docking stand. The motorised scooter may be unlocked if another rider wishes to hire the motorised scooter. Of course, an operator of the motorised scooter is able to lock or unlock the motorised scooter in order to shift, maintain, repair or configured the motorised scooter. The motorised scooter is possible to be handled by a single coupling, completing locking, transacting or examining over the motorised scooter. A rider is possible to view details of his hiring, usage or transaction over the motorised scooter via his mobile communication device, a computer portal, an internet connected television or a display panel at the docking station, or with any other user interfaces.

The offering (e.g. unlocking) the one or more suitable motorised scooters can comprise a step of selecting a motorised scooter with a suitably replenished motorised scooter. Since a docking bay (i.e. a docking place with multiple docking stations or charging stands) often has several motorised scooters, the docking bay is able to examine and indicate (e.g. by flashing LED indicators) sufficiently replenished motorised scooters for hiring. Selection of the motorised scooter can depend on specific rider or user requirements. For example, if the docking bay receive a rider's journey information of six kilometre distance, the docking bay may offer electric scooters that are charged above 80%. Alternatively, the docking bay may offer a heavy-duty scooter to a rider who wishes to carry heavy luggage or possess heavy body weight.

The method may additionally comprise a step of forecasting usage of the one or more motorised scooters. For example, an operator may predict that more motorised scooters at transport hubs (e.g. MRT stations or subway stations) are required during peak hours, whilst many motorised scooters are demanded at parks during weekends. The operator thus may shift motorised scooters to the transport hubs shortly before the peak hours, and/or move the motorised scooters near parks by the end of Friday.

The method can further include a step of examining the one or more motorised scooters automatically. The examination can also be known as health check to the motorised scooters, such as inspecting fuel tank level, checking battery charge percentage, screening roadworthiness, or performing handshaking of electronic communication. The examination can be performed automatically by the motorised scooter, the docking station, the remote computing server or a combination of any of these. Regular, routine or frequent examination ensures high quality and availability of the motorised scooter, providing excellent user or rider satisfaction. A rider is known as a person of riding a motorised scooter, whilst a user is known as a person engaging some forms of serves of the motorised scooter. For example, a user (e.g. mother) can engage an operator for renting a motorised scooter for her son, who is a rider of the motorised scooter.

The method may optionally comprise a step of tracking location of the one or more motorised scooters. Location or geographical positions of the one or more motorised scooters may be known, whether the one or more motorised scooters are stationary at docking stations, or moving during their journeys or hiring. An operator of the one or more motorised scooters is able to be updated on precise locations of the motorised scooters, ready to move any motorised scooter to a place of higher demand. The method can further comprise a step of moving the one or more motorised scooters to another location depending on customer demand.

The accompanying figures (Figs.) illustrate embodiments and serve to explain principles of the disclosed embodiments. It is to be understood, however, that these figures are presented for purposes of illustration only, and not for defining limits of relevant inventions.

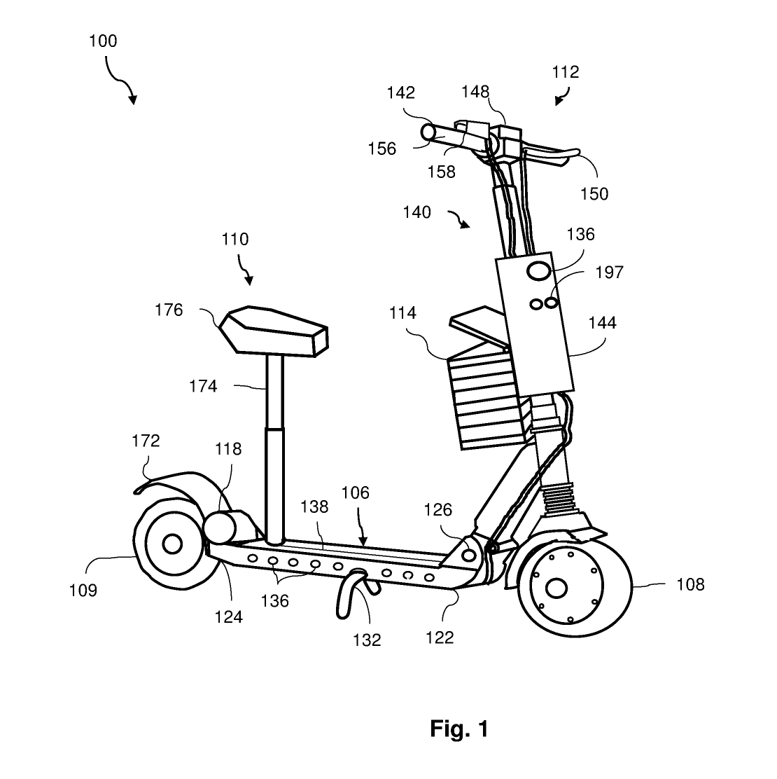

FIG. 1 illustrates a first embodiment of an electric scooter;

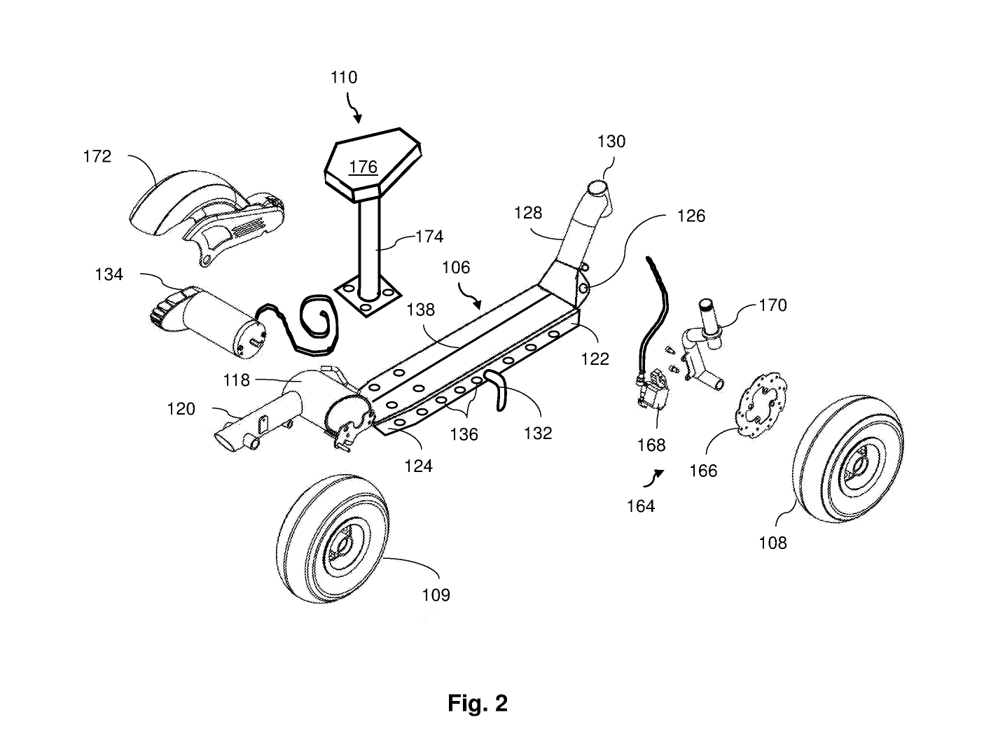

FIG. 2 illustrates a blown up perspective of the electric scooter having a foot deck, a plurality of ground contacting elements and a seat unit;

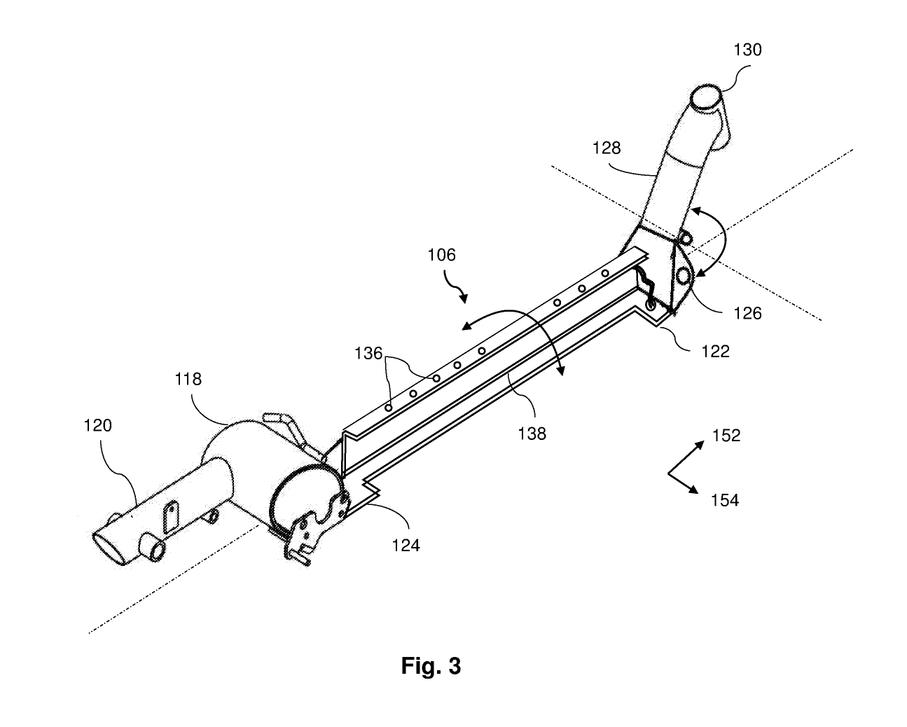

FIG. 3 illustrates a folded foot deck of the electric scooter;

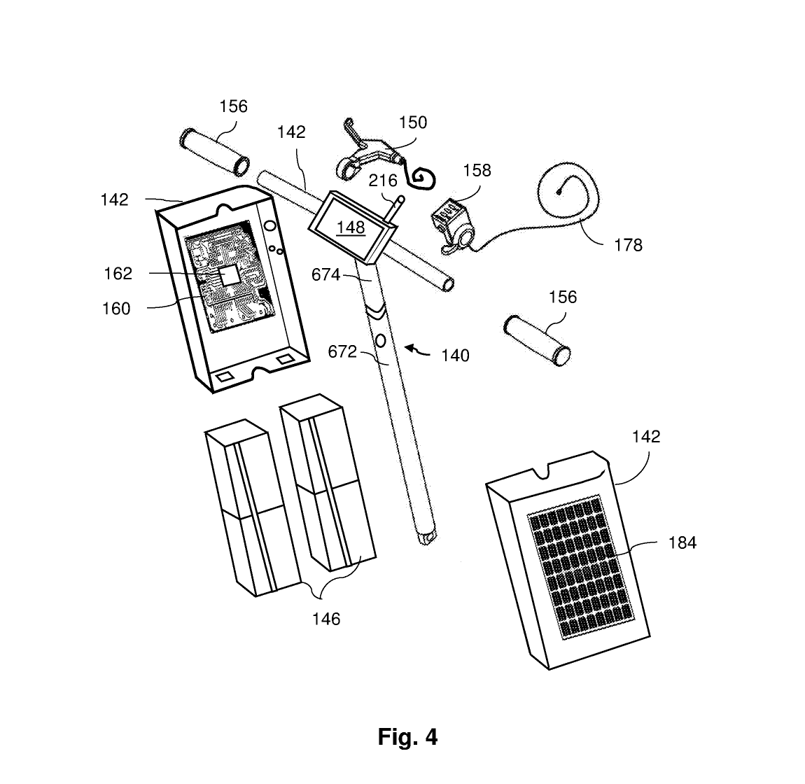

FIG. 4 illustrates a blown up perspective of the electric scooter having a steering unit;

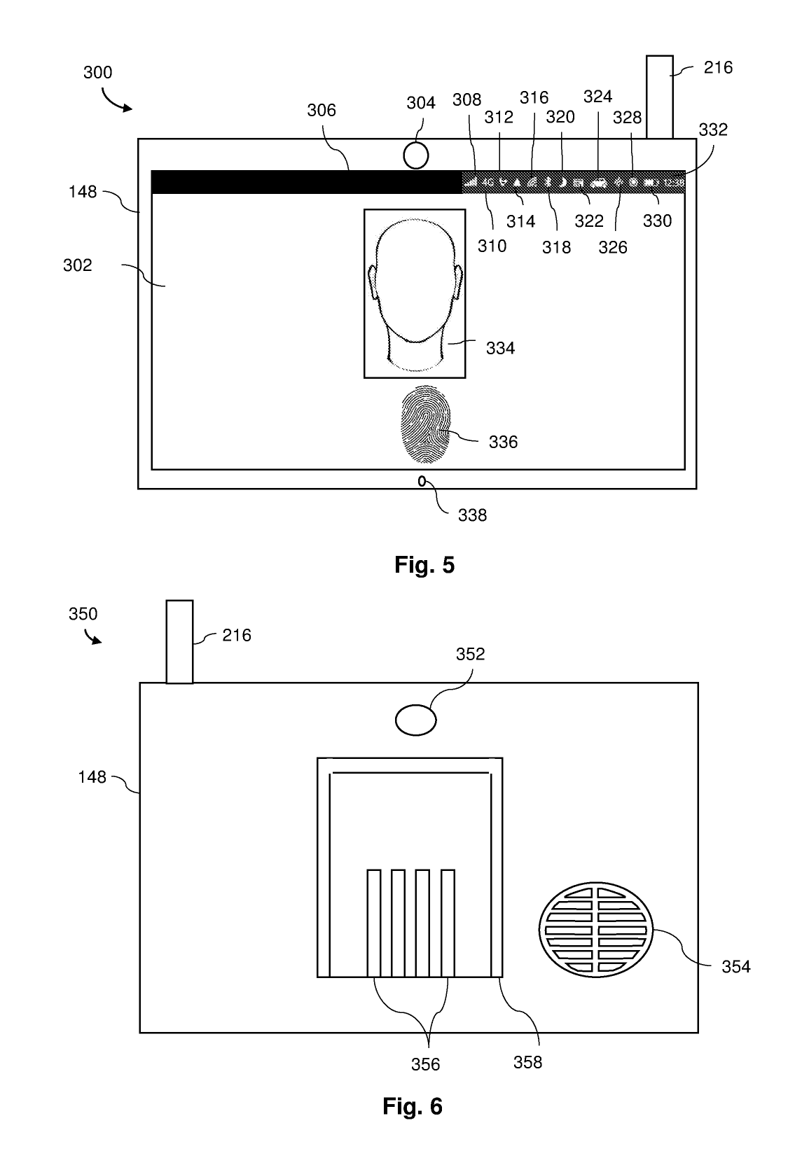

FIG. 5 illustrates a tactile display from a frontal perspective;

FIG. 6 illustrates the tactile display from a back perspective;

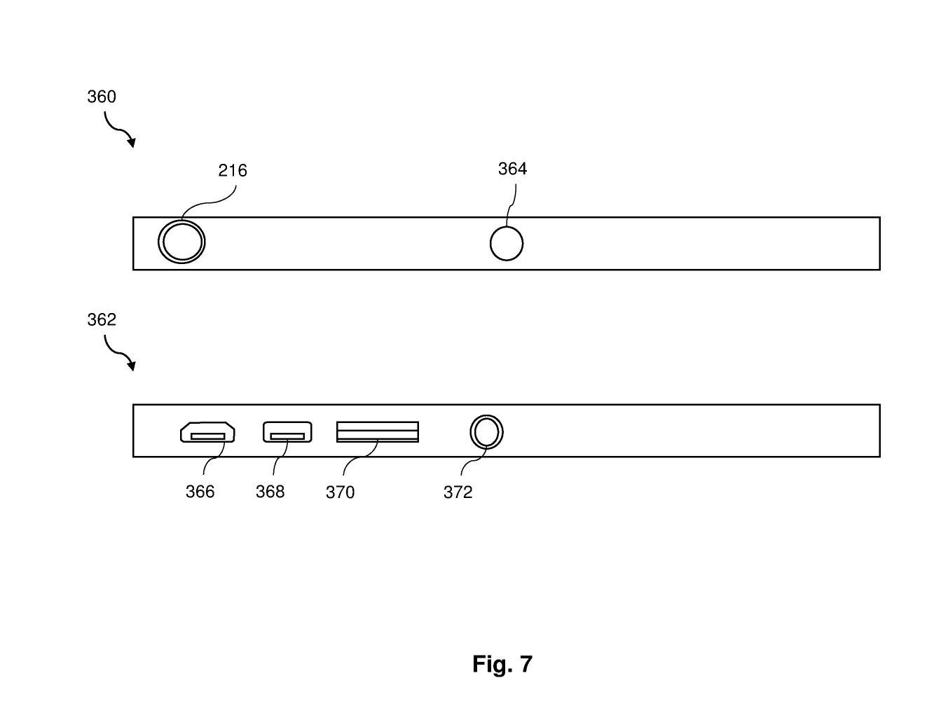

FIG. 7 illustrates the tactile display from a top and a bottom perspective;

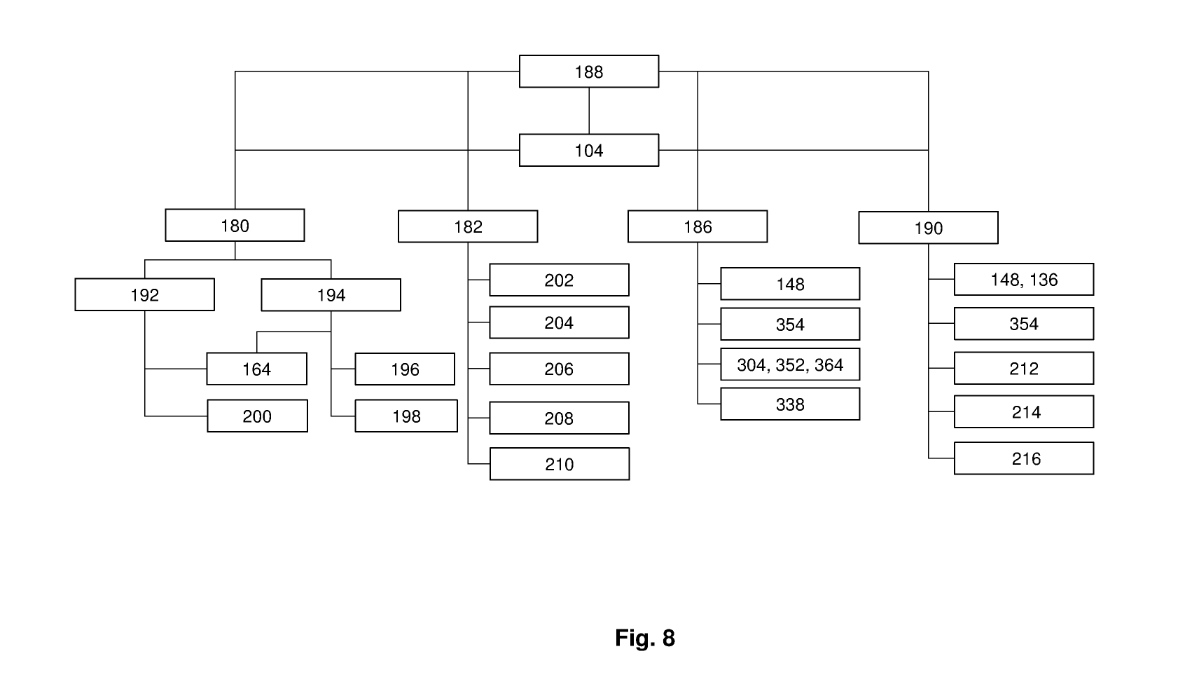

FIG. 8 illustrates a control unit;

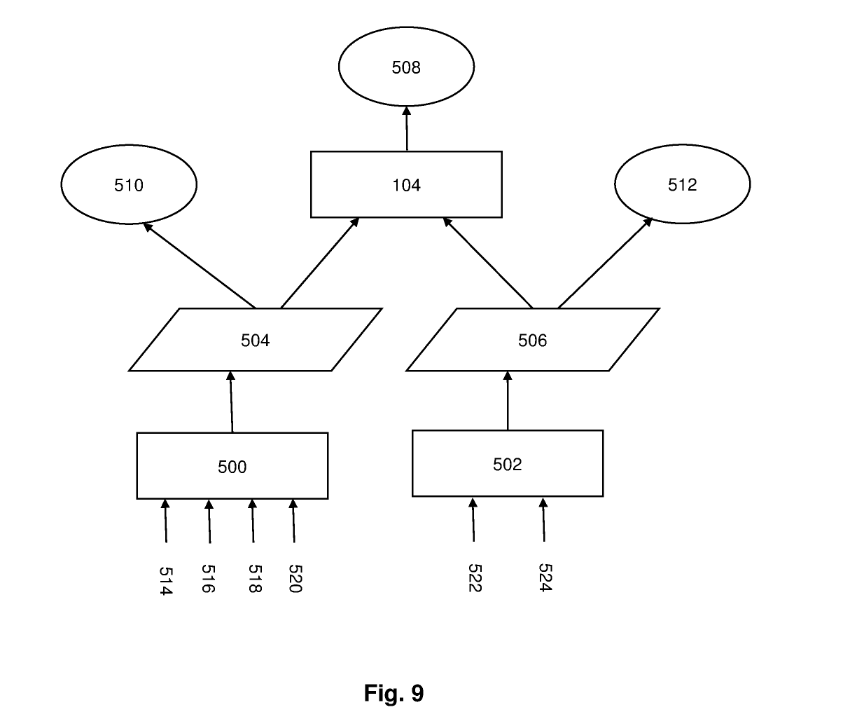

FIG. 9 illustrates a schematics of the control unit;

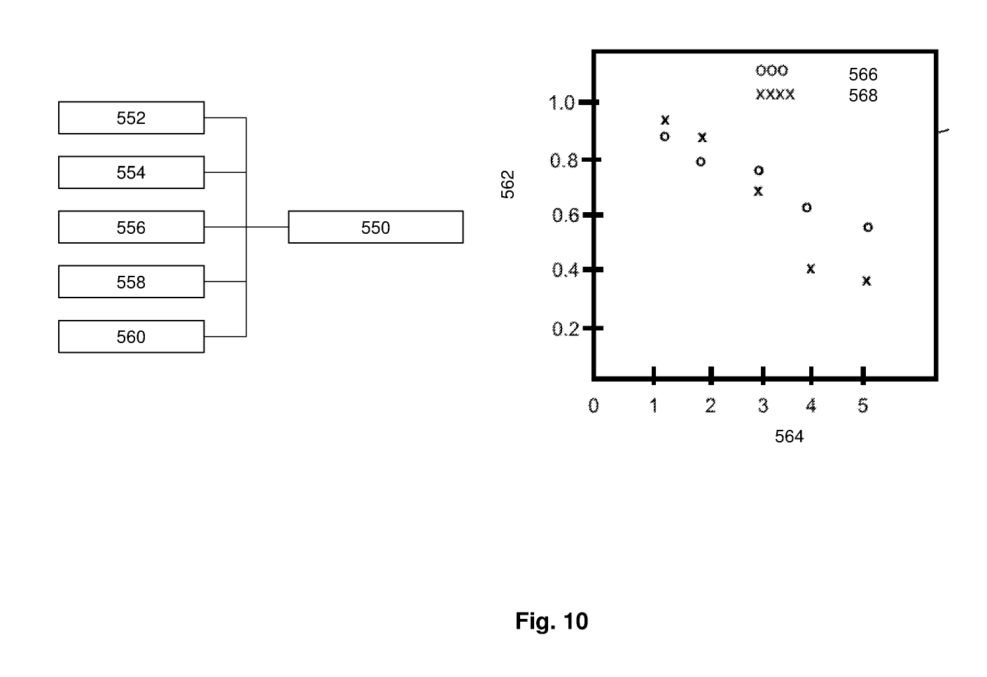

FIG. 10 illustrates a predictive modelling represented by a survival probability versus a future usage chart;

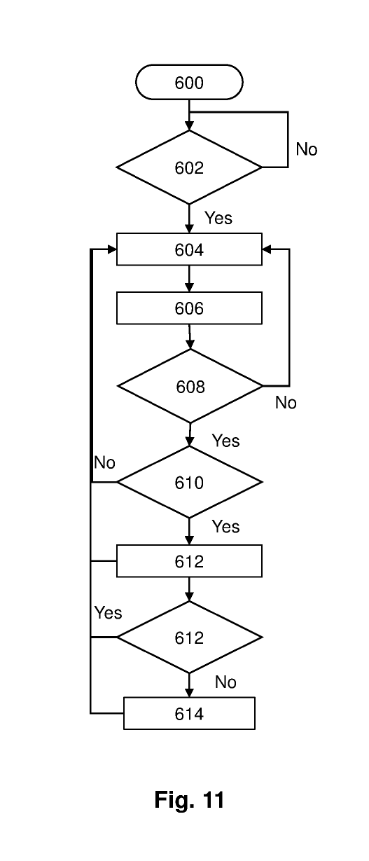

FIG. 11 illustrates a process flow of a geospatial analytics module;

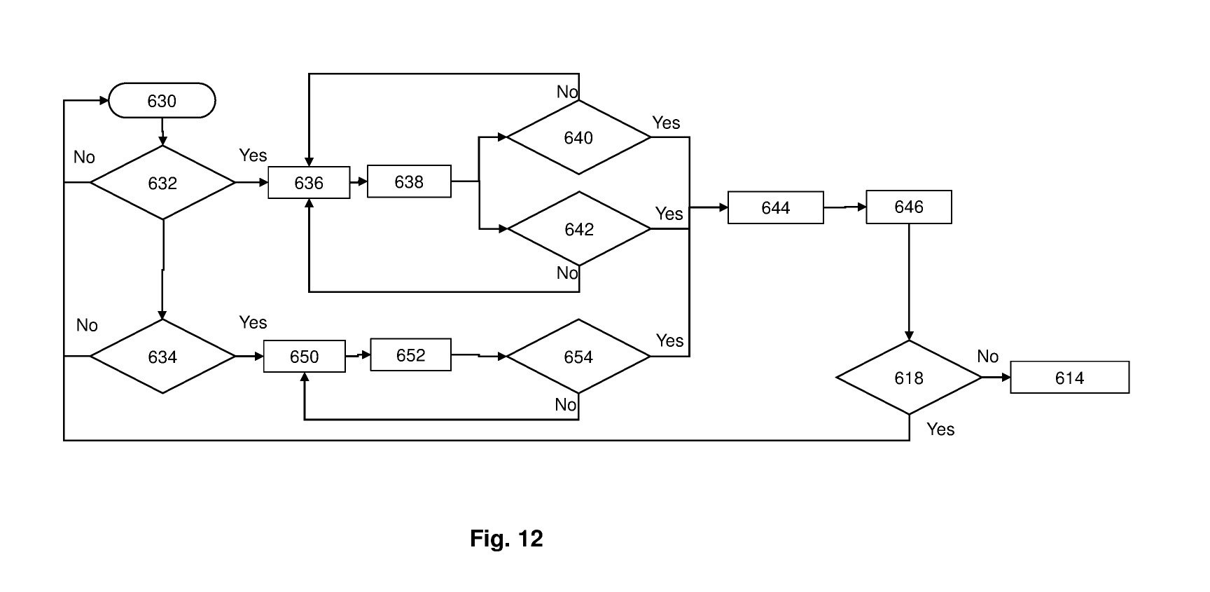

FIG. 12 illustrates a video and audio analytics module;

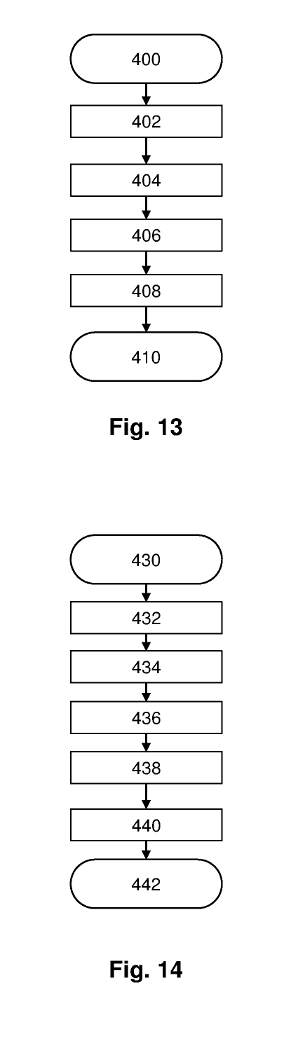

FIG. 13 illustrates a method of initiating the electric scooter;

FIG. 14 illustrates a method of operating the electric scooter;

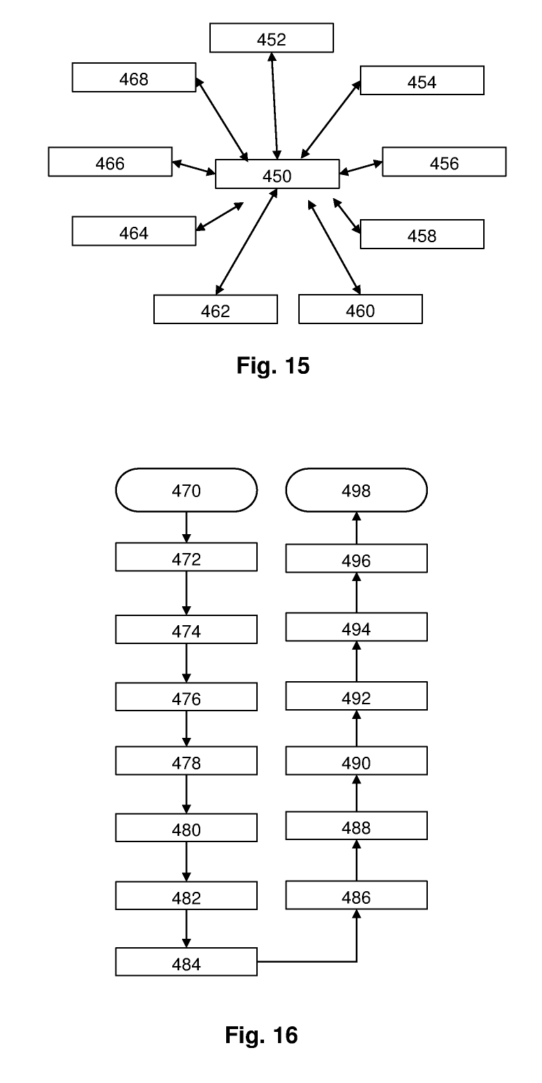

FIG. 15 illustrates the modes of operation of a control unit;

FIG. 16 illustrates a method of assembly and disassembly of the electric scooter;

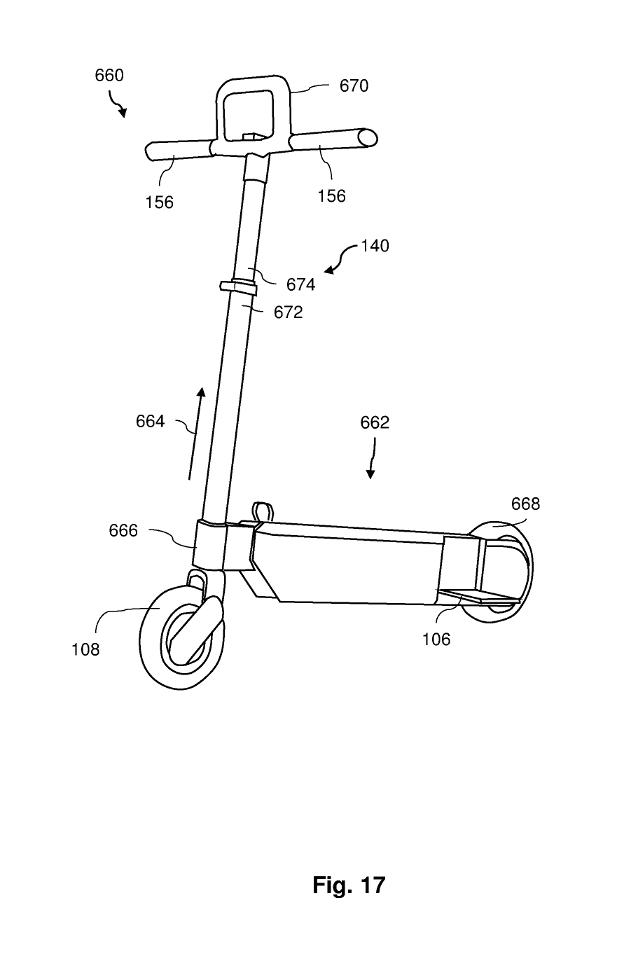

FIG. 17 illustrates a second embodiment of the electric scooter in an expanded state; and

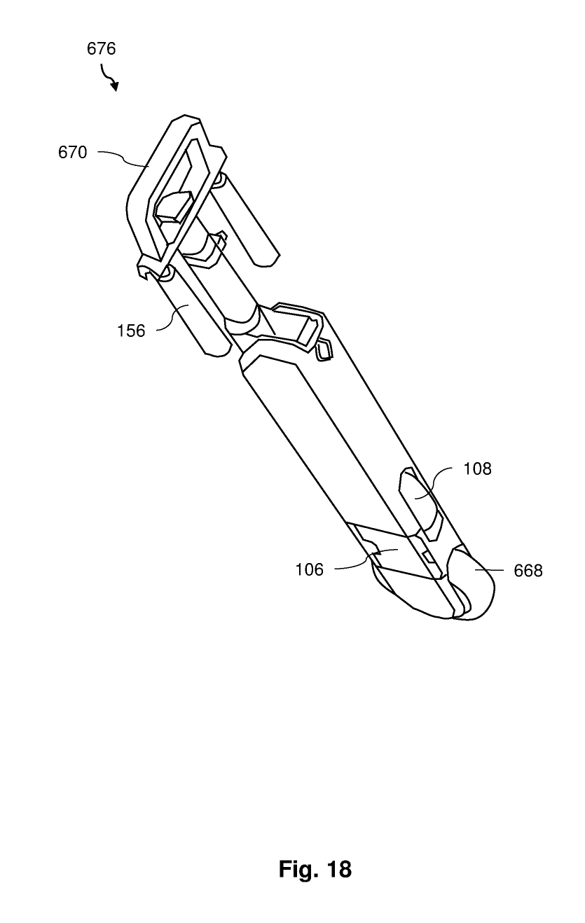

FIG. 18 illustrates the second embodiment of the electric scooter in a folded state.

Exemplary, non-limiting embodiments of the present application will now be described with references to the above-mentioned figures.

FIGS. 1 to 4 illustrate a first embodiment of an electric scooter 100. In particular FIG. 1, shows the electric scooter from a right side frontal perspective. The electric scooter 100 comprises a framework 102, a control unit 104, a plurality of ground contacting elements 108,109 and an engine 134. The framework 102 further comprises a foot deck 106, a steering unit 112, a carrier 114, a seat unit 110 and a balancing unit 116 (not shown).

FIG. 2 illustrates a blown up perspective of the electric scooter 100 having a foot deck 106, a plurality of ground contacting elements 108,109 and a seat unit 110. The foot deck 106 is a flat, polygonal block having a rear end 124 join to a hollow cylindrical motor housing 118. The motor housing 118 is interposed between the rear end 124 of the foot deck 106 and a cylindrical beam 120 join on a one side of the motor housing 118. The front end 122 of the foot deck 106 having a pivotal joint 126 is joined to a neck 128 and the neck 128 join to a head tube 130. At the centre bottom of the foot deck 106 is a support stand or a kickstand 132. An electric motor 134 is inserted into the cylindrical motor housing 118.

A plurality of light emitting diodes 136 lining the two lengths of the foot deck 106. The foot deck 106 has a hinged-like folding line 138 running along the middle of the foot deck 106. The foot deck 106 is made of waterproof and flexible composite like carbon fibre. The light emitting diodes 136 are also located at the front of the casing 144 along the steering column 140.

Below the foot deck 106 is a plurality of pressure sensors (not shown) which are connected to a microcontroller 162 in a casing 144 along a steering column 140. Alternatively, aluminium can be used to construct the framework 102 of the electric scooter 100.

FIG. 3 illustrates a folded foot deck 106 of the electric scooter 100. A one-half of the foot deck 106 is flipped upwards about the middle hinged-line folding line 138 or about the z-axis 152. The foot deck 106 width is shortened by half due to the folding mechanism. The neck 128 with the head tube 130 is rotatable about the pivotal joint 126 or about the x-axis 154. The foot deck 106 and the neck 128 communicates with each other about the pivotal joint 126 hence reducing the storage space if necessary. The pivotal joint 126 is in a normally locked position. A spring-loaded bolt at the pivotal joint is depressed into the hole to enable the folding action about the x-axis 154. An electrical connection is visible from the underside of the foot deck 106 going through a hole which connect the plurality of light emitting diodes to the control unit 104 (not shown).

FIG. 4 illustrates a blown up perspective of the electric scooter 100 having a steering unit 112. The steering unit 112 comprising a steering column 140 and a handlebar 142 with two handgrips 156 on both ends of the handlebar 142. The handlebar 142 is attached to a top end of the steering column 140. A battery unit 146 is attached to the middle of the steering column 140. A brake lever 150 is attached to the left hand side of the handlebar 142. A LED (Light Emitting Diode) tactile display 148 is attached at the centre of the handlebar 142 acting as a dashboard. A gear shifter 158 is attached to the right hand side of the handlebar 142. The battery unit 146 comprises a casing 144, at least a battery unit 146, a printed circuit board 160 with surface mounted electronic components which include the microcontroller 162 and connections to a plurality of external peripheral components. The peripheral components comprise input sensing devices and output devices as well as to the battery unit 146. The casing 144 having holes facing the front and at the bottom. At the bottom of the casing 144 are a plurality of electrical conductors (not shown). An opposite end of the steering column 140 is inserted into the head tube 130 of the foot deck 106 which is extended and attached to a front one-arm fork 170 having a disc brake unit 164 and a front wheel 108. The brake lever 150 having a brake cable is connected to a hydraulic brake unit at the front one-arm fork 170. The gear shifter 158 having a gear cable 178 is connected to the electric motor 134 at the rear of the foot deck 106. The disc brake unit 164 comprises a disc brake 166 and a hydraulic braking unit 168.

Referring to FIG. 2, the plurality of ground contacting elements 108, 109 comprises the front wheel 108 and the rear wheel 109. The front wheel 108 is supported by a front axle. The front axle is formed angularly to a one-arm fork 170. A disc brake 166 of the disc brake unit 164 is inserted through the front axle followed by the front wheel 108. The hydraulic braking unit 168 having a clamp structure is fixed to the one-arm fork 170 with the disc brake 166 positioned in between the hydraulic braking unit 168. The rear wheel 109 is supported by a rear axle (not shown) which is fixed to the cylindrical beam 120 attached to the cylindrical motor housing 118. The rear wheel 109 has a mud guard 172 positioned above. The front wheel 108 and the rear wheel 109 are made of urethane or elastomer which are durable and provides heat retardant property.

The carrier 114 is attached to the steering column 140. The carrier 114 is made of insulated metallic wire. The seat unit 110 comprises an adjustable seating column 174 and a saddle 176 on a top end of the seating column 174. An opposite end of the seating column 174 is attached to the rear end 124 of the foot deck 106. The seating column 174 and the saddle 176 are made of carbon composite to provide waterproofing property. The balancing unit 116 having a plurality of sensors located at the bottom of the foot deck 106 and the handlebar 142.

The framework 102 provides a support for the various components of the electric scooter 100. The foot deck 106 provides a base support for the standing of a human rider as well as the support of the seat unit 110. It also provides a support of the front wheel 108, the electric motor 134 and the rear wheel 109. The LED that is along the lengths of the foot deck 106 provides illumination for visibility to other road users. The electric motor 134 provides a locomotive drive for the electric scooter 100 which derives its energy source from the battery unit 146 located at the steering column 140 via an electrical connection (not shown). Alternatively, the electrical energy source can be derived from a solar panel 184 as shown in FIG. 4.

The foot deck 106 is foldable about the pivotal joint 126 to the steering column 140. The foot deck 106 having the hinged-like folding line 138 running along the centre length of the foot deck 106 provides a folding of the foot deck 106 making it compact for storage. The pressure sensors beneath the foot deck 106 provides a measurement of the weight of the rider when stepping on the foot deck 106. This information is fed to the microcontroller 162 for recording and processing. Extra load factoring of about 5% of the body weight capped at a maximum weight of a hundred kilogrammes is considered into the measured weight to provide for the transport of other miscellaneous items like bags, helmet and others. The hundred-kilogramme is an example and the criteria can be changed according to specific requirements.

In addition, the pressure sensors can also detect if there were load present. If there were no load it would imply that the rider has dismounted and therefore electrical supply to the electric motor should be off. This is also a safety feature in the event the rider had a mishap and fell from the foot deck 106, the pressure sensors detecting a no load will cut the electrical supply immediately to the electric motor 134. Otherwise, the rider may not have the opportunity to adjust the gear shifter 158 on the handlebar 142 and the electric scooter 100 could have crashed into other road users or public installation.

The pivotal joint 126 having a mechanism providing a lock and release spring tension actuated device having a plurality of lock tracks on a nut wherein the lock tracks define a plurality of the steering column positions. A slider pivots with the steering column 140 and is able to slide between a lock position and a release position. In the lock position, the slider engages one of the lock tracks. In the release position, the slider does not engage the lock track to allow the steering column 140 to pivot in between. The slider is spring-biased toward the lock position.

The steering column 140 comprises a static outer tube 672 and an inner rotatable cylindrical tube 674. The inner rotatable cylindrical tube 674 provides a height adjustment.

The steering column 140 provides a rotational control of the direction of travel of the electric scooter 100 by the handlebar 142. The handlebar 142 provides at least one handgrip 156 for either a left hand or a right hand of the rider. To turn to the right side, the rider pulls the right side handlebar 142 closer to himself or herself. To turn to the left side, the rider pulls the left side handlebar 142 closer to himself or herself. The left handlebar 142 has a brake lever 150 with the brake cable that actuates the hydraulic brake unit at the one-arm fork 170 supporting the disc brake unit 164 and the front wheel 108. The gear shifter 158 with the gear cable 178 at the right handlebar 142 is connected to the electric motor 134 for controlling the speed of the rotation of the motor which drives the rear wheel 109. The steering column 140 is extendable for the adjusting of different heights for different riders' needs. The steering column 140 and the one-arm fork 170 are removed by unscrewing a headset at the head tube 130. The headset is the set of components on an electric scooter 100 that provides a rotatable interface between the one-arm fork 170 and the head tube 130.

The casing 144 along the steering column 140 having holes at the front provide placement of sensors and receivers for the detection of obstacles ahead of the electric scooter 100. There are holes and windows 197 along the periphery of the casing 144 that provides ventilation to the components inside the casing 144 as well as LIDAR 196,198 and ARS 200 sensors and light emitting diodes 136. The electrical conductors at the bottom of the casing 144 (not shown) provide a channel for the charging of the battery unit 146 in the casing 144 when the electric scooter is folded about the x-axis 154. There is a corresponding electrical contacts at a docking station to provide the charging of the battery unit 146. There is also an auxiliary electrical socket or charging connector at the bottom of the casing 144 for plugging in of a connector that is connected to the mains (public utility).

The LED tactile display 148 is located at the centre of the handlebar 142 providing a convenient way for the rider to access information by a touch of a finger. The LED tactile display 148 provides an input channel as well as an output channel. The LED tactile display 148 is connected to the printed circuit board 160 residing inside the casing 144 of the battery unit 146. THE LED tactile display 148 provides an adjustable back lit display screen for improved visibility for low light condition. The LED tactile display 148 also provides an anti-glare screen for easier viewing by the rider. The LED tactile display 148 can be swivelled at the handlebar providing multi-angle viewing options. The LED tactile display 148 can be easily attached and detached by sliding into a handlebar mount. The LED tactile display 148 is an example. Alternatively, the tactile display 148 can be of any existing or future technologies that provide both a visual display channel and an input channel.

The printed circuit board 160 having a microcontroller 162 provides electrical connection and software algorithm for processing signal inputs and generating associated outputs. The microcontroller 162 is also known as an on-board computer 162 and is the processing engine 162 of the control unit 104.

The mud guard 172 above the rear wheel 109 provides a secondary braking means by stepping on the mud guard 172. The action of stepping on the mud guard 172 provides a frictional force with the rear wheel 109 causing the travelling electric scooter 100 to decelerate or come to a halt. The mud guard 172 also provides a protection from the splattering of dirt and debris on the rider when travelling. The mud guard 172 is releasable by unscrewing a Hex socket bolt using a Hex key (Allen key).

The wheels are easily detachable using a plurality of quick release skewers. The quick release skewer is a mechanism for attaching a wheel to the electric scooter 100. The quick release skewer consists of a rod threaded on one end and with a lever operated cam assembly on the other. The rod is inserted into the hollow axle of the wheel, a special nut is threaded on, and the lever is closed to tighten the cam and secure the wheel to the one-arm fork 170.

The carrier 114 provides a container for the holding of helmet, gloves and other items that free the rider from holding. The carrier 114 is collapsible, foldable and easily removable by unscrewing a Hex socket bolt using a Hex key (Allen key).

The seating column 174 is extendable for the adjustment of the seating height for different riders' needs. The saddle 176 provides a seat for the rider to sit on. The saddle 176 is slidingly removable or adjustable along the seating column 174 by the quick release mechanism. The seating column 174 is detachable from the foot deck 106 by unscrewing the bolts from the nuts. Alternatively, for easy removal from the foot deck 106, the base of the seating column 174 can be made to slide into an arrestor. The arrestor is a corresponding contraption to secure the base.

The balancing unit 116 controls the direction of movement as well as balancing the electric scooter 100. An on-board computer computes based on the software algorithm and inputs from sensors at the handlebar 142, inputs from sensors below the foot deck 106, input sensors from a plurality of liquid leveller located at specific positions of the base frame. The information from the sensors provides information to allow the computer to determine the amount of compensation and correction to stabilise the motorised scooter. For example, sensors like proximity sensors can be used on the handlebar 142 and pressure sensors under the stepping platform and the grip parts of the handlebar 142.

The stability of the electric scooter 100 can be established using the principle of water levelling. The simplest stability detection is to use a water level which is a section of clear tubing forming a “U” shape, partially filled with water placed in the right to left section of the foot deck 106. Two sensors are positioned at the two ends of the “U” tubing are to detect the water level in each tube end. If the electric scooter 100 is tilted to the right, the water level at the right tubing end will be elevated and the water level at the left tubing end will drop. Upon detecting the difference in the water level, the sensors will be triggered and send the information to the on-board computer. The on-board computer has the software algorithm that will attempt to balance the electric scooter 100 by controlling the steering column 140 that includes the front wheel 108. However, this arrangement from right to left only detect the instability at one plane. More water levels have to be added to achieve a higher stability. Alternatively, a MEMS (microelectromechanical system) gyroscope can be used to provide the sensor inputs to the microcontroller 162 for processing and micro adjustment of the front wheel 108 to achieve stability. Another alternative is to use a gyro-stabilizer.

Alternatively, the disc brake unit 164 can be replaced by a horseshoe brake (U-brake) or a cantilever brake or a V-brake. The alternative braking systems uses a Bowden cable which is a flexible cable used to transmit mechanical force by the movement of an inner cable relative to a hollow outer cable housing. The cable housing is generally of composite construction, consisting of an inner lining, a longitudinally incompressible layer such as a helical winding or a sheaf of steel wire and a protective outer covering. The brake itself is a calliper type, to press two or more surfaces together in order to convert, via friction, kinetic energy of the electric scooter 100 and rider into thermal energy to be dissipated.

Alternatively, the gear shifter 158 which is operated by moving a right thumb can be replaced with a twist grip throttle providing a handgrip 156 for the changing of the speed of the electric motor 134.

FIGS. 5 to 7 illustrate the tactile display. In particular FIG. 5 illustrates the tactile display 148 from a frontal perspective 300. The tactile display 148 provides a rectangular frame comprising a top length, a bottom length, a right breadth and a left breadth. The front of the tactile display 148 presents an anti-glare screen 302. A frontal camera 304 is located at the top length of the tactile display 148. On the anti-glare screen 302 the top region displays a status bar 306 of the control unit 104 comprising a mobile signal strength 308 icon, a mobile data connection 310 icon, a call forwarding 312 icon, a roaming 314 icon, a WiFi connection 316 icon, a Bluetooth 318 icon, a quiet hour 320 icon, a notification 322 icon, a riding mode 324 icon, a ringer 326 icon, a location 328 icon, a battery 330 icon and a clock 332 icon. At the centre of the anti-glare screen 302 is an image of the rider 334 and a fingerprint 336. At the bottom length of the tactile display 148 is a microphone 338. A conduit of the breathalyzer 216 is located at the top right side of the tactile display 148.

The frontal camera 304 provides an image capture of the rider as well as live video recording during the use of the electric scooter 100. The image of the rider 334 provides a visual identification during a registration. The acquired image of the rider 334 allows the control unit 104 to verify the identity of the rider with the registered image. The control unit 104 may connect to a remote server to perform the verification. In addition, the control unit 104 also requires a biometric identity of the rider which in the example is a fingerprint 336. The image of the rider 334 is associated with the fingerprint 336. Detailed information is acquired at the tactile display 148 after the rider's image 334 and fingerprint 336 acquisition comprising a first name, a last name, an identification number, a mobile phone number and an electronic mail address.

The status bar provides the rider with a visual status of the communication channels available which includes GSM, GPRS, Wi-Fi or LTE, and Bluetooth of the electric scooter 100. Respective antennae and protocols are installed at the control unit 104 providing remote communication with the remote server.

The breathalyzer 216 provides a conduit for the rider to exhale into a tube to estimate the blood alcohol content (BAC). When the user exhales into a breath analyzer, any ethanol present in the exhaled breath is oxidized to acetic acid at the anode:

CH₃CH₂OH (gas)+H₂O (liquid)→CH₃CO₂H (liquid)+4H⁺ (aqueous)+4e⁻

At the cathode, atmospheric oxygen is reduced:

O₂(g)+4H⁺ (aqueous)+4e⁺→2H₂O (liquid)

The overall reaction is the oxidation of ethanol to acetic acid and water.

CH₃CH₂OH (liquid)+O₂ (gas)→CH₃COOH (aqueous)+H₂O (liquid)

The electric current produced by this reaction is measured by the microcontroller 162, and displayed as an approximation of overall blood alcohol content (BAC). When in use, a cap is removed to expose the conduit allowing the rider to exhale from the mouth into the conduit. Frequent sterilising is required for hygiene purpose. Alternatively, a disposable sleeve can be installed at the conduit prior to exhaling to skip the sterilising.

FIG. 6 illustrates the tactile display 148 from a back perspective 350. A back camera 352 is located at the top length of the tactile display 148. A speaker 354 is located at the bottom left breadth of the tactile display 148. At the centre is a plurality of electrical contacts represented by four rectangular strips 356. Encompassing the rectangular electrical contact 356 is a rectangular inverted “U” protrusion 358. The U protrusion 358 provides a ridge for the sliding into a corresponding “U” mount having a groove located at the centre of the handlebar 142. The U protrusion provides a seal preventing dust and water from contacting the electrical contacts 356.

The back camera 352 provides an image or video capture at the front in the range of about one metre of the electric scooter 100. The back camera 352 is to capture the immediate short frontal happenings of the electric scooter 100. In the event of an incident or a dispute, there will be a video recording prior to the incident or dispute. The rectangular electrical contact 356 provides electrical power and data transmission to the control unit 104 locating inside the casing 144 along the steering column 140.

FIG. 7 illustrates the tactile display 148 from the side top length 360 and the side bottom length 362 perspectives. The side top length 360 at the centre having an ahead camera 364. The ahead camera 364 provides the image or video capture of the road condition ahead of the electric scooter 100.

The side bottom length 362 having four sockets comprising a USB Micro-B plus 366, a lightning connector 368, a type-A receptacle 370 and an earphone jack 372 having a diameter of 2.5 millimetres. The sockets provide a convenience and connection with the rider's mobile devices.

The microphone 338 provides an audio input to the control unit 104 for learning and processing. The algorithm in the MCU 162 takes the audio input from the microphone 338 and the video/image input from the front camera 304, the back camera 352 and the ahead camera 364 to control the movement of the electric scooter 100 taking evasive manoeuvre if necessary to avoid a collision. The rider can also use the microphone 338 to communicate with the electric scooter 100 orally instead of using the finger to perform entry on the tactile display 148. The angle of the tactile display 148 can be adjusted by the rider.

FIG. 8 illustrates a control unit 104 having a microcontroller 162 further comprises a locomotion unit 180, a telematics unit 182, a human machine interface (HMI) unit 186, a power management unit 188 and a communication module 190.

The microcontroller (MCU) 162 having one or more processor cores along with memory and programmable input/output peripherals. The memory in the form of ferroelectric RAM (Random Access Memory), NOR (negation of the OR operator) flash or OTP (One Time Programmable) ROM is included on the chip and a small amount on RAM. The MCU 162 is surface mounted on the printed circuit board 160 with other components and is located inside the casing 144 along the steering column 140.

The locomotion unit 180 comprises an adaptive cruise control unit 192 and an emergency brake unit 194. The emergency brake unit 194 further comprises the disc brake unit 164 of the front wheel 108, a Short Range Light detection and ranging (LIDAR) unit 196, a short range LIDAR camera 198 and a long range advance radar sensor (ARS) 200. The adaptive cruise control unit 192 comprises the ARS 200 and the disc brake unit 164.

The telematics unit 182 comprises a AM/FM (Amplitude Modulation/Frequency Modulation) radio unit 202, a WLAN (Wide Local Area Network) unit 204, a BTLE (Bluetooth Low Energy) and WIFI (Wireless Fidelity) unit 206, a LTE/UMTS (Long Term Evolution/Universal Mobile Telecommunications Service) unit 208, and a GNSS (Global Navigation Satellite System) unit 210. The various units of the telematics unit 182 provide the corresponding antennae for transmitting and receiving information wirelessly via different transmission frequencies. The telematics unit 182 is located in the casing 144 along the steering column 140.

The HMI unit 186 comprises the LED tactile display 148, a plurality of cameras 304,352,364, a sound projection unit 354 and a microphone 338. The HMI unit 186 is located at the centre of the handlebar 142. The HMI unit 186 has a water rating of IP58 (International Protection Marking) which provides dust resistant and immersion in a depth of 1.5 metres of freshwater for up to thirty minutes.

The power management unit (PMU) 188 comprises the battery unit 146. The power management unit 188 is located in the casing 144 along the steering column 140 on-board the printed circuit board 160. The PMU 188 provides electrical power to the control unit 104, the locomotion unit 180, the telematics unit 182, the HMI unit 186 and the communication module 190.

The communication module 190 comprises a visual means, the sound projection unit, a plurality of connectors 212, an electronics identification means 214 and a means to detect blood alcohol content 216.

The visual means specifically relates to the LED tactile display 148 and the light emitting diodes 136 at the lengths of the foot deck 106. The sound projection unit is the same speaker 354 which was mentioned at the HMI unit 186. The connectors are USB (Universal Serial Bus) connectors, for example, Micro-B plus, UC-E6, Mini-B plug, type-A receptacle, lightning connector (proprietary Apple connector). The connectors are located at the periphery of the side bottom length 362 along the LED tactile display 148. There is a charging connector (not shown) which is located beneath the casing 144 along the steering column 174.

The electronics identification means 214 may comprise but not limited to a QR (Quick Response) code, a barcode or a serial number or a combination of the identification means. The electronics identification means are located at the handlebar 142 for ease of visual identification by the rider. The means to detect blood alcohol content 216 provides a breathalyzer 216 which is located at the side top length 360 of the tactile display 148 as shown in FIG. 5.

The MCU 162 provides processing of inputs from the locomotion unit 180, the telematics unit 182, the HMI unit 186, the power unit and the communication module 190. The MCU 162 contains a software programme that takes the inputs from the various units and provides a plurality of outputs typically but not limited to control the movement of the electric scooter 100 and the information to display at the LED tactile display 148.

The locomotion unit 180 provides an autonomous control of the electric scooter 100. The emergency brake unit 194 uses the Short Range Light detection and ranging (LIDAR) unit 196 for detecting obstacles. The short range LIDAR camera 198 is used to detect human presence and obstacles. The long range advance radar sensor (ARS) 200 provides a far and wide angle of coverage ahead of the electric scooter 100. For long distance riding, the electric scooter 100 is enabled to maintain a constant travelling velocity. The ARS 200 provides the detection of remote obstacles ahead to prevent the electric scooter 100 from potential collision. The ARS 200 is capable of determining the distance to an object in real time scanning and dependent on the driving speed up to a distance of 200 metres. The ARS 200 can even detect road traffic technology, for example, traffic light approximation recognition.

The electric scooter 100 uses LIDAR 196 to navigate safely through environments using rotating laser beams. There is a plurality of holes at the casing 144 facing the front providing windows 197 for emitting pulses of laser beam (600 to 1550 nm) and detecting a return signal by a hole mirror or a beam splitter. Alternatively, photodetector and receiver electronics can be used, for example, solid state photodetectors, such as silicon avalanche photodiodes, or photomultipliers.

Upon detection of obstacles or human, the disc brake unit 164 will be activated to slow down or to halt. This is determined by the software algorithm that is programmed in the MCU 162. Alternatively, the software algorithm may instruct the power unit to switch off the electrical supply to the electric motor 134.

The telematics unit 182 provides information to the rider or remote users on the location of the electric scooter 100 through a global positioning system (GPS) unit as well as external interface for mobile communications like GSM, GPRS, Wi-Fi or LTE providing tracked values to a centralised geographical information system (GIS) database server. The information may be relayed to a remote server for storing, analysing, processing, monitoring, and controlling. One example of such a module may be a GSM/GPRS module—SM5100B with an operating temperature range of 10° C. to 55° C., typical voltage usage of 3.3 Volts to 4.2 Volts, and able to support a SIM (Subscriber Identification Module) card.

The tracked values provide the monitoring of location, movements, status and behaviour of one electric scooter 100 or a fleet of electric scooters 100. This is achieved through a combination of a GPS and GNSS receiver and the MCU 162 usually comprising a GSM GPRS modem or SMS (Short Messages Service) sender installed at the MCU 162 of the electric scooter 100, communicating with the rider. The data is turned into information by management reporting tools in conjunction with the LED tactile display 148 on computerised mapping software. A plurality of electric scooters 100 can be managed remotely by having the telematics unit 182 installed on more than one electric scooter 100. An API (Application Programming Interface), or program is developed, installed and operating at the MCU 162 to integrate the data from each electric scooter 100 into a remote database controlled by a remote server. The remote communication between the electric scooter 100 and the remote server provides a single point of control for the monitoring of the status of the electric scooters 100. The API also provides a remote enablement or disablement of the electric scooter 100. In other words, the API can lock or unlock the electric scooter 100.

Alternatively, the electric scooter 100 may use odometry (i.e. odometer) or dead reckoning as a complementary means of navigation. Odometry is the use of data from motion sensors to estimate change in position over time. Dead reckoning (DR) is the process of calculating the electric scooter's 100 current position by using a previously determined position and advancing that position based upon known or estimated speeds over elapsed time and course.

The HMI unit 186 provides interaction between the rider and the electric scooter 100 through the LED tactile display 148 and the input sensors. The camera of the HMI unit 186 is to detect the presence of a rider to capture a facial image of the rider. The acquired rider's facial image is saved for identification. A road condition camera can be attached pointing to the front to record a video of the road conditions and the location as the electric scooter 100 travels on the road. The acquired video footage is analysed by the software algorithm at the MCU 162 to detect human and obstacles. The recorded information can be sent to a remote server or a cloud for remote users to access. The LED tactile display 148 screen provides a biometric reader for acquiring a fingerprint. The fingerprint provides an authentication of the rider before the activation of the electric scooter 100. The sound projection unit of the HMI unit 186, for example, a speaker 354 provides an audible signal receptive to the human ears either an alarm when there is an unauthorised access or to a melody to indicate the location of the electric scooter 100. The speaker 354 can be used to project an instructional voice, for example, guiding the rider on the direction of travel to get to a destination. The microphone 338 provides a channel for converting the ambient sound including voices of human into electrical signal variations which may be amplified, transmitted or recorded. The recorded electrical signal is analysed for patterns that may be associated to voices of human at a crowded bus stop, the horns of vehicles, sirens of emergency vehicles. All the sound and video recordings are stored in a memory bank which is connected to the MCU 162 for processing. The memory bank is located on the printed circuit board 160 for quick access. For long term storage, access and study by other users, the recorded data may be uploaded onto the remote server.

The power management unit 188 provides managing and monitoring of an electrical source to the control unit 104 and to the electric motor 134 via a data communication bus. The electrical source is supplied by the battery unit 146 which is a rechargeable battery (cell or battery pack). The power management unit 188 protects the battery unit 146 from operating outside its safe operating area (voltage and current conditions), monitoring its operating state, calculating secondary data, reporting the secondary data, controlling its environment, authenticating it and/or balancing it. The environment refers to the ambient temperature surrounding the battery unit 146. The power management unit 188 monitors the state of the battery unit 146 comprising the following parameters. The voltage parameter includes total voltage, voltages of individual cells, minimum and maximum cell voltage of periodic taps. The temperature parameter includes average temperature of individual battery unit 146. The state of change (SOC) or depth of discharge (DOD) parameters to indicate the charge level of the battery. The state of health (SOH) parameter which is a defined measurement of the overall condition of the battery. The coolant flow parameter for air cooled batteries. The current parameter provides a monitoring of the current in or out of the battery unit 146. The power management unit 188 also performs computation such as maximum charge current, maximum discharge current, the energy delivered since last charge, internal impedance of a battery to determine open circuit voltage, total operating time since first use, total number of charge cycles and total energy delivered since first use. The power management unit 188 communicates internally with the battery unit 146 via the MCU 162 or externally with high level hardware such as a laptop. Alternatively, the electrical source can be from at least one solar cell panel.

The communication module 190 provides a convenience for the rider to locate the electric scooter 100 either visually by the flashing of the light emitting diodes 136 or audibly by playing a melody. The connectors provide a connector for the charging of mobile devices as well as charging of the electric scooter 100. The electronic identification means specifically the QR code provides a web link to a webpage when scanned with the relevant mobile phone application which initiate some form of registration to a remote server. The QR code uniquely identifies the electric scooter 100. The registration can be a for a first time activation of a new electric scooter 100, for example, some form of warranty registration. Alternatively, the registration can be for the usage of the electric scooters 100 in a sharing scheme. The means to detect blood alcohol provides a breathalyzer 216 which is a genericized trademark for an instrument that tests the alcohol level in a breath sample. The breathalyzer 216 is internally connected to the microcontroller 162 for analysing and processing.

FIG. 9 illustrates a schematics of the control unit 104 having different software modules, a plurality of variables being inputted to the said modules and generating a plurality of predetermined outputs based on the algorithm on-board the MCU 162. The software modules comprising a geospatial analytics module 500 and a video/audio analytics module 502.

The geospatial analytics module 500 provides the processing of the inputs comprising the location based on the GPS data 514, the travelling speed 516 based on the relative distances of the electric scooter 100 and the satellites in the outer space and the current speed limit rules 520 which is based on the location of the electric scooter 100. A foreknowledge of the speed limit rules must be applied at the MCU 162. Alternatively, the speed limit rules may be retrieved from a remote server which may belong to a third party vendor. In addition, the knowledge of the location via the GPS data also provides a plurality of geo-fences 518 which can be exploited to trigger a response when the electric scooter 100 leaves or enters an area (location). The output generated from the assimilation of the inputs provides a determination of the possible violation as stated by the Personal Mobility Device (PMD) Rule Violations 504.

The video/audio analytics module 502 provides the processing of the inputs comprising the audio signal 524 and the video signal 522 which provide an output that determines the traffic pattern classification 506.

The outputs from the two modules 500, 502 are fed to the control unit 104 where appropriate control output actions 508 are generated to control the electric scooter 100. Singularly from the geospatial analytics module 500 and the video/audio analytics module 502, the output generates an alert for rule violation 510 and an alert for an emergent situation 512.

FIG. 10 illustrates a predictive modelling 550 represented by a survival probability 562 versus a future usage 564 chart. The software algorithm takes in variables relating to the electric scooter 100 comprising a usage 552, a maintenance history 554, an equipment log and error code 556, a deployed location 558 and a user profile 560. Based on the variables, the software algorithm adopts a predictive modelling approach to generate the survival probability 562 versus the future usage 564 chart as shown in the FIG. 10 having two equipment A 566 and equipment B 568. The predictive model 550 will continually be achieving a more accurate prediction as more data are collated from a plurality of electric scooters 100.

FIG. 11 illustrates a process flow of a geospatial analytics module 500. The geospatial analytics module 500 checks if the GPS/WiFi/LTE is available 602. If available, the location coordinates are acquired 604. Conversely, the module 500 will continue probing for GPS signal. The location of the electric scooter 100 is tracked 606 and updated at the on-board memory storage.

The geospatial analytics module 500 will then check whether the electric scooter 100 is inside a geofence 608 (i.e. geo-fence). If the electric scooter were not in the geofence it will continue acquire the GPS coordinates. On the contrary, if the electric scooter 100 were in the geofence, the geospatial analytics module 500 checks whether the speed limit is violated 610. If the speed limit were exceeded, the electric scooter 100 will reduce the travelling speed automatically 612.

The geospatial analytics module 500 continues to check the travelling speed of the electric scooter 614. If the travelling speed were not reduced, an alert is sent to a remote server or an audible alert activated.

FIG. 12 illustrates a video and audio analytics module 603. The video and audio analytics module 603 checks the availability 632 of the video cameras 304,352,364 and checks the availability 634 of the microphone 338.

The video cameras 304, 352, 364 acquire streaming images 636 and analyse the differences between individual images 638 to detect motion 640 and detect oncoming vehicles 642. In both scenarios 640, 642, the travelling speed of the electric scooter 100 will be reduced 644. The acquired images are stored on-board the memory storage 646.

The electric scooter 100 is continually probed for travelling speed. The rider has the autonomy to increase the travelling speed despite the auto speed reduction function is in place. The video and audio analytics module 603 checks whether the travelling speed is within speed limit 648. If the speed limit were exceeded in the geofence, an alert will be activated either audio or reporting to a remote server 614.

Similarly, for the audio detection, the audio signal is acquired 650 and analysed 652 and perform a comparison with a similar sound 654 which is stored in the database. A found similarity will reduce the travelling speed 644 of the electric scooter 100. The similarity is determined by a plurality of specific frequency harmonics. The audio signal may not be identical. The variant audio signal is then stored in the memory storage.

The expanding stored information ensures a continuous improvement in the prediction modelling when the electric motor 100 travels longer and covering a bigger area. The acquired information is then shared with other road users and other electric scooters 100.

FIG. 13 illustrates a method of initiating the electric scooter 100. The method of initiating and personalising the electric scooter 100 by the rider for a first use 400 comprises the following steps. The first step is to activate the LED tactile display 148 by placing a finger on the display screen 402. The LED tactile display 148 is connected to the microcontroller 162 and the power unit. The second step is to acquire the particulars 404 of the rider comprising a first name, a last name, an identification number, a mobile phone contact number and an electronic mail address. The third step is to acquire a finger print 406 by the LED tactile display 148. The fourth step is to acquire a weight measurement 408 of the rider with no load by standing at the foot deck 106. A plurality of pressure sensors located beneath the foot deck 106 and connected to the microcontroller 162. The algorithm at the microcontroller 162 will save the information acquired at the memory bank at the microcontroller 162. The information can also be uploaded to a remote server provided there is a data network access via the on-board telematics unit 182. Prior to initiation, the electric scooter 100 is disabled in which the electric motor 134 is non-operational.

FIG. 14 illustrates a method of operating the electric scooter. The method of operating the electric scooter 100 by the rider 430 comprises the following steps. The first step 432 is to place the finger on the LED tactile display 148 screen allowing the sensor to acquire the fingerprint. The second step 434 is to exhale into the breathalyzer 216 in which the result will determine whether the rider is fit to ride on the electric scooter 100. If the alcohol level is within acceptable range, the rider is permitted to ride on the electric scooter 100. The electric scooter 100 will be enabled and the electric motor 134 is on with the rear wheel 109 unlock. The third step 436 is to place the hands on the left and the right grip parts at the handlebar 142. The fourth step 438 is to place at least one foot on the foot deck 106. The pressure sensors will sense the weight of the rider and add another 5% of the body weight to account for a bag carried by the rider and the worn helmet. The balancing unit 116 balances the electric scooter 100 with the rider standing on the foot deck 106. The fifth step 440 is to activate the gear shifter 158 at the left side of the handlebar 142 by a thumb to activate the electric motor 134 providing the driving force to the rear wheel 109.

FIG. 15 illustrates the modes of operation of a control unit 104. The modes of operating the electric scooter 100 by the control unit 104 having the microcontroller 162 comprises the following modes. The first mode 452 involves acquiring the fingerprint from the LED tactile display 148 of the HMI unit 186. The second mode 454 involves acquiring the personal particulars from the LED tactile display 148 comprising a first name, a last name, an identification number, a mobile phone contact number and an electronic mail address. The third mode 456 involves acquiring the weight of the rider from the pressure sensors at the foot deck 106. The fourth mode 458 involves storing the acquired information at the memory bank at the microcontroller 162. The fifth mode 460 involves acquiring the result from the breathalyzer 216 and analysing the result. The sixth mode 462 involves activating the electric motor 134 and the power unit from the microcontroller 162. The seventh mode 464 involves updating the remote server with the location of the electric scooter 100 via the telematics unit 182. The telematics unit 182 is communication with the remote server provides the location of the electric scooter 100. The rider having a mobile phone with the appropriate mobile application is able to approximate the location of the electric scooter 100. The telematics unit 182 having the knowledge of the rider's proximity will illuminate the LEDs 136 along the foot deck 106 and initiate an audible sound of the communication module 190. The eighth mode 466 involves charging the electric scooter 100 which is initiated by the power management unit 188 having the knowledge of the remaining charge and the operating life cycle of the battery unit 146. The ninth mode 468 involves the controlling the speed of the electric scooter 100 by detecting obstacles ahead by the locomotion unit 180.

FIG. 16 illustrates a method of assembly and disassembly of the electric scooter. The method of assembling and disassembling the electric scooter 100 comprises the following steps. The first step 472 is to form by moulding a foot deck 106 having an electric motor housing 118 at the rear end 124 and the headset at the opposite end where a pivotal joint 126 is interposed between the foot deck 106 and the neck 128. The neck 128 is joined to the headset. The length of the foot deck 106 is foldable at the middle.

The second step 474 is to install the electric motor 134 into the electric motor housing 118. The third step 476 is to attach the rear wheel 109 to the rear end 124 of the foot deck 106 communicating with the electric motor 134. The fourth step 478 is to encompass the casing 144 having the battery unit 146 and the control unit 104 along the steering column 140. At the surface of the casing 144 is a solar panel 184 that is connected to the battery unit 146 for electrical storage. The fifth step 480 is to route an electric motor cable from the electric motor 134 to the casing 144 along the steering column 140. The electric motor cable is connected to the MCU 162 via a relay circuit and then another electric motor cable is routed to the gear shifter 158 at the right side of the handlebar 142. The sixth step 482 is to attach the one end of the steering column 140 through the headset. The seventh step 484 is to attach the one-arm fork 170 to the one end of the steering column 140. The eighth step 486 is to attach a handlebar 142 at the opposite end of the steering column 140. The ninth step 488 is to insert the disc brake 166 through an axle of the one-arm fork 170. The tenth step 490 is to insert the front wheel 108 through the axle of the one-arm fork 170. The eleventh step 492 is to route the brake cable from the disc brake unit 164 at the front wheel 108 to the casing 144 along the steering column 140. The brake cable is connected to the MCU 162 via a relay circuit and then another brake cable is routed to the gear shifter 158 at the left side of the handlebar 142. The twelfth step 494 is to attach the collapsible and foldable basket along the rear side of the casing 144. The thirteenth step 496 is to attach the seat unit 110 to the foot deck 106.

The locomotion of the electric scooter 100 is electronically controlled coupled with human interaction which includes the movement and the braking. An algorithm in the MCU 162 considers the battery level, the road condition (hard or soft surface, wet or dry surface) and the weight of the rider to determine the optimal braking distance as well as the travelling speed.

The method of charging the battery unit 146 of the electric scooter 100 comprises checking the battery level of the battery unit 146 via the power management unit 188 and charging the battery unit 146 based on the time of the day.

In particular, the electric scooters 100 are used by commuters regularly during peak working hours. For example, the electric scooter 100 may have a remaining battery level of 50%, the likelihood of these electric scooters 100 being used again is high during the day and hence to commence charging for the electric scooter 100 is not necessary. However, during after day hours, a full battery charge is recommended.

FIG. 17 illustrates a second embodiment of the electric scooter 100 in an expanded state whereby the foot deck 106 is a foldable flap located adjacent to the rear wheel 109. The base chassis 662 carries a battery unit (not shown). The front end of the base chassis 662 having a cylindrical hollow tube 666 that is slidable along the steering column 140 as indicated by the arrow 664. The opposite end of the base chassis 660 supports a rear wheel. The rear wheel is a brushless DC (Direct Current) hub wheel 668 which is powered by the battery unit. At the top end of the steering column 140 is a handle and two separate handgrips 156.

The steering column 140 comprises a static outer tube 672 and an inner rotatable cylindrical tube 674. The inner rotatable cylindrical tube 674 provides a height adjustment. The handgrips 156 provides two grip parts for the two hands of the rider. The right hand handgrip 156 provides a handgrip throttle for controlling the electric motor 134.

FIG. 18 illustrates the second embodiment in a folded state 676. The handgrips 156 are folded towards the steering column 140. The front wheel 108 is visible in the base chassis 662. The base chassis 662 has a recess (not shown) that can accommodate the steering column 140 and the front wheel 108. The right foot deck and the left foot deck 106 are folded towards the sides of the base chassis 662.

The electric scooter 100 in the present application provides a personal mobility vehicle (PMD) for transporting a rider having an on-board processor that is able to communicate with a remote user via a plurality of current networking technologies. A remote user is able to monitor and control the status and state of the electric motor 100 remotely. The remote user has the ability to control the movement as well as the route to travel. The electric scooter 100 is also capable of balancing without human intervention. The on-board processor is also capable of collecting real-time data comprising audio and video. In addition, the on-board processor in cooperation with the other units is able to provide location tracking, locomotion controlling (obstacle avoidance), battery monitoring and human to machine interaction through a tactile display. The electric scooter 100 is modularly constructed to provide easy replacements of defective parts.

In the application, unless specified otherwise, the terms “comprising”, “comprise”, and grammatical variants thereof, intended to represent “open” or “inclusive” language such that they include recited elements but also permit inclusion of additional, non-explicitly recited elements.

As used herein, the term “about”, in the context of concentrations of components of the formulations, typically means+/−5% of the stated value, more typically +/−4% of the stated value, more typically +/−3% of the stated value, more typically, +/−2% of the stated value, even more typically +/−1% of the stated value, and even more typically +/−0.5% of the stated value.

Throughout this disclosure, certain embodiments may be disclosed in a range format. The description in range format is merely for convenience and brevity and should not be construed as an inflexible limitation on the scope of the disclosed ranges. Accordingly, the description of a range should be considered to have specifically disclosed all the possible sub-ranges as well as individual numerical values within that range. For example, description of a range such as from 1 to 6 should be considered to have specifically disclosed sub-ranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

It will be apparent that various other modifications and adaptations of the application will be apparent to the person skilled in the art after reading the foregoing disclosure without departing from the spirit and scope of the application and it is intended that all such modifications and adaptations come within the scope of the appended claims.

Reference Numerals

| | |
|---|---|
| 100 | electric scooter |
| 102 | frame unit |
| 104 | control unit |
| 106 | foot deck |
| 108 | front wheel, ground contacting element |
| 109 | rear wheel, ground contacting element |
| 110 | seat unit |
| 112 | steering unit |
| 114 | carrier |
| 116 | balancing unit |
| 118 | motor housing |
| 120 | cylindrical beam |
| 122 | front end of the foot deck |
| 124 | rear end of the foot deck |
| 126 | pivotal joint |
| 128 | neck |
| 130 | head tube |
| 132 | support stand, kickstand |
| 134 | electric motor, engine |
| 136 | light emitting diodes |
| 138 | hinged-like folding line |
| 140 | steering column |
| 142 | handlebar |
| 144 | casing |
| 146 | battery unit |
| 148 | tactile display, LED tactile display |
| 150 | brake lever |
| 152 | z-axis |
| 154 | x-axis |
| 156 | handgrips |
| 158 | gear shifter |
| 160 | printed circuit board |
| 162 | microcontroller, MCU |
| 164 | disc brake unit |
| 166 | disc brake |
| 168 | hydraulic braking unit |
| 170 | front one-arm fork |
| 172 | mud guard |
| 174 | seating column |
| 176 | saddle |
| 178 | gear cable |
| 180 | locomotion unit |
| 182 | telematics unit |
| 184 | solar panel |
| 186 | human machine interface (HMI) unit |
| 188 | power management unit |
| 190 | communication module |
| 192 | adaptive cruise control unit |
| 194 | emergency brake unit |
| 196 | Short Range Light detection and ranging (LIDAR) unit |
| 197 | windows |
| 198 | short range LIDAR camera |
| 200 | long range advance radar sensor (ARS) |
| 202 | AM/FM unit |
| 204 | WLAN unit |
| 206 | BTLE and WiFi unit |
| 208 | LTE/UMTS unit |
| 210 | GNSS unit |
| 212 | plurality of connectors |
| 214 | electronics identification means |
| 216 | means to detect blood alcohol content, breathalyzer |
| 300 | frontal perspective of a tactile display |
| 302 | anti-glare screen |
| 304 | frontal camera |
| 306 | status bar |
| 308 | mobile signal strength |
| 310 | mobile data connection |
| 312 | call forwarding |
| 314 | roaming |
| 316 | WiFi connection |
| 318 | Bluetooth |
| 320 | quiet hour |
| 322 | notification |
| 324 | riding mode |
| 326 | ringer |
| 328 | location |
| 330 | battery |
| 332 | clock |
| 334 | image of the rider |
| 336 | fingerprint |
| 338 | microphone |
| 350 | back perspective of a tactile display |
| 352 | back camera |
| 354 | speaker, sound projection unit |
| 356 | rectangular electrical contact |
| 358 | U protrusion |
| 360 | side top length |
| 362 | side bottom length |
| 364 | ahead camera |
| 366 | USB Micro-B plus |
| 368 | lightning connector |
| 370 | type-A receptacle |
| 372 | earphone jack |
| 400 | Initiating and personalising the electric scooter for first use |
| 402 | Screen activation by finger |
| 404 | Acquire rider's particulars |
| 406 | Acquire fingerprint of the rider |
| 408 | Acquire weight of the rider |
| 410 | End of initiating and personalising the electric scooter for first use |
| 430 | Operating the electric scooter |
| 432 | Acquiring the fingerprint of the rider |
| 434 | Acquiring the blood alcohol content of the rider |
| 436 | Gripping the handgrips with both hands |
| 438 | Stepping at least one foot on the foot deck |
| 440 | Activating the gear shifter |
| 442 | End of operating the electric scooter |
| 450 | Operation of the Control Unit |
| 452 | Acquiring fingerprint from the tactile display |
| 454 | Acquiring personal details from the tactile display |
| 456 | Acquiring the weight from the pressure sensors |
| 458 | Storing the acquired data at the memory bank |
| 460 | Acquiring the blood alcohol content, processing and analysing |
| 462 | Activating the electric motor |
| 464 | Updating the remote server with the location of the electric scooter |
| 466 | Charging the electric scooter |
| 468 | controlling the speed of the electric scooter |
| 470 | Assembly and disassembly of the electric scooter |
| 472 | forming the foot deck |
| 474 | installing the electric motor |
| 476 | attaching the rear wheel to the rear end of the foot deck |
| 478 | encompassing the casing |
| 480 | routing an electric motor cable from motor the casing |
| 482 | attaching steering column to the headset |
| 484 | attaching one-arm fork to the steering column |
| 486 | attaching a handlebar at the opposite end of the steering column |
| 488 | inserting the disc brake through an axle of the one-arm fork |
| 490 | inserting the front wheel through the axle |
| 492 | routing the brake cable from the disc brake to the casing |
| 494 | attaching the basket to the casing |
| 496 | attaching the seat unit to the foot deck |
| 498 | End of assembly and disassembly of the electric scooter |
| 500 | geospatial analytics module |
| 502 | video/audio analytics module |
| 504 | PMD Rule Violations |
| 506 | traffic pattern classification |
| 508 | control output actions |
| 510 | rule violation alert |
| 512 | emergent situation alert |
| 514 | GPS |
| 516 | Speed |
| 518 | Geofences |
| 520 | Speed limit rules |
| 522 | Video signal |
| 524 | Audio signal |
| 550 | predictive modelling |
| 552 | usage |
| 554 | maintenance history |
| 556 | equipment log and error code |
| 558 | deployed location |
| 560 | user profile |
| 562 | survival probability |
| 564 | future usage |
| 566 | equipment A |
| 568 | equipment B |
| 600 | Start of geospatial analytics module |
| 602 | GPS/WiFi/LTE available? |
| 604 | Acquiring location coordinates |
| 606 | electric scooter tracked and updated at microcontroller |
| 608 | electric scooter inside geofence? |
| 610 | speed limit violated? |
| 612 | reduce speed automatically |
| 614 | alert |
| 630 | start of video and audio analytics module |
| 632 | video camera available? |
| 634 | microphone available? |
| 636 | acquire streaming images |
| 638 | analyse the image |
| 640 | detect motion |
| 642 | detect oncoming vehicles |
| 644 | reduce travelling speed |
| 646 | storage of information |
| 648 | Within speed limit? |
| 650 | acquire audio signal |
| 652 | analyse the audio signal |
| 654 | similar sound found? |
| 660 | second embodiment of an expanded electric scooter |
| 662 | Base chassis |
| 664 | arrow indication the direction of slide |
| 666 | cylindrical hollow tube |
| 668 | brushless DC hub wheel |
| 670 | handle |
| 672 | static outer tube |
| 674 | rotatable cylindrical tube |
| 676 | second embodiment of a folded electric scooter |

1. A motorised scooter comprising
a framework for supporting a rider;
a ground engaging element connected to the framework for moving the framework;
an engine connected to the ground engaging element for propelling the ground engaging element; and
a brake further connected to the framework, the ground engaging element, the engine or a combination of any these for stopping the motorised scooter.

2. The motorised scooter of claim 1 further comprising
an energy source that is connected to the engine for providing energy to the engine.

3. The motorised scooter of claim 1 or 2 further comprising
a control unit that is connected to the engine for regulating the engine.

4. The motorised scooter of claim 3, wherein
the control unit comprises a user interface for operating the motorised scooter.

5. The motorised scooter of claim 4, wherein
the user interface comprises a dashboard for displaying information of the motorised scooter.

6. The motorised scooter of any of the preceding claims 3 to 5, wherein
the control unit further comprises a lock for preventing operation of the motorised scooter.

7. The motorised scooter of any of the preceding claims 3 to 6, wherein
the control unit further comprises a navigation device for providing geographical location information relating to the motorised scooter.

8. The motorised scooter of any of the preceding claims 3 to 7, wherein
the control unit further comprises an alarm device for indicating malfunctioning of the motorised scooter.

9. The motorised scooter of any of the preceding claims 3 to 8, wherein
the control unit further comprises a recorder for recording usage data of the motorised scooter.

10. The motorised scooter of any of the preceding claims 3 to 9, wherein
the control unit further comprises an object detector for checking road obstacles.

11. The motorised scooter of claim 10, wherein
the object detector comprises a radar, Lidar or both.

12. The motorised scooter of any of the preceding claims 3 to 11, wherein
the control unit is configured to regulate the motorised scooter according to geo-fence for compliance.

13. The motorised scooter of claim of any of the preceding claims 3 to 12, wherein
the control unit further comprises an energy source regulator that is connected to the energy source for managing the energy source according to at least one predetermined protocol automatically.

14. The motorised scooter of any of the preceding claim 13, wherein
the energy source regulator comprises a charging connector that is weatherproof.

15. The motorised scooter of any of the preceding claims 3 to 13, wherein
the control unit further comprises a communication terminal for tracking location of the motorised scooter.

16. The motorised scooter of claim 15, wherein
the communication terminal comprises a computer port for data communication.

17. The motorised scooter of any of the preceding claims, wherein
at least one component of the motorised scooter comprises modular structure for coupling or decoupling.

18. The motorised scooter of any of the preceding claims, wherein
the framework comprises a stabiliser for balancing the motorised scooter automatically.

19. The motorised scooter of claim 1 or 18, wherein
the framework is made of light-weight material or structure.

20. The motorised scooter of any of the preceding claims, wherein
at least a portion of motorised scooter surfaces is configured to be self-clean.

21. A method for using a motorised scooter, the method comprising:
receiving a request to use at least one motorised scooter;
notifying location of the at least one suitable motorised scooter;
offering the at least one suitable motorised scooter; and
getting back the at least one suitable motorised scooter.

22. The method of claim 21 further comprising
transacting the at least one suitable motorised scooter.

23. The method of claim 21 or 22, wherein
the transacting the at least one suitable motorised scooter comprises associating an electronic identifier of the at least one suitable motorised scooter.

24. The method of any of the preceding claims 21 to 23 further comprising
replenishing an on-board energy source of the at least one motorised scooter automatically.

25. The method of any of the preceding claims 21 to 24 further comprising
communicating with a mobile communication device of a user.

26. The method of any of the preceding claims 21 to 25 further comprising
locking the at least one suitable motorised scooter.

27. The method of claim 21, wherein
the offering the at least one suitable motorised scooter comprises selecting the at least one motorised scooter from available motorised scooters according to the request.

28. The method of any of the preceding claims 21 to 27 further comprising
examining the at least one motorised scooter according to roadworthiness.

29. The method of any of the preceding claims 21 to 28 further comprising
tracking location of the at least one motorised scooter.

30. The method of any of the preceding claims 21 to 29 further comprising
moving the at least one motorised scooter to another location.
